(19) United States
(12) Patent Application Publication
(10) Pub. No.: US 2022/0318796 A1
(43) Pub. Date: Oct. 6, 2022

(54) STABLE TOKEN CREATION, PROCESSING AND ENCRYPTION ON BLOCKCHAIN

(71) Applicant: MShift, Inc., Palo Alto, CA (US)

(72) Inventors: Xiaomeng ZHOU, Redwood City, CA (US); Scott MOELLER, Samut Prakarn (TH); Jacqueline SNELL, Sacramento, CA (US); Andrew YEE, San Francisco, CA (US); David TCHEAU, Redwood City, CA (US); Denny TRAN, South San Francisco, CA (US); David DENG, San Mateo, CA (US)

(21) Appl. No.: 17/684,324

(22) Filed: Mar. 1, 2022

Related U.S. Application Data
(63) Continuation-in-part of application No. 17/680,072, filed on Feb. 24, 2022.
Application No. 17/680,072 is a continuation of application No. PCT/US20/48297, filed on Aug. 27, 2020.
(60) Provisional application No. 63/156,231, filed on Mar. 3, 2021.
(60) Provisional application No. 63/055,774, filed on Jul. 23, 2020.
(60) Provisional application No. 63/053,444, filed on Jul. 17, 2020.
(60) Provisional application No. 62/927,595, filed on Oct. 29, 2019.
(60) Provisional application No. 62/899,665, filed on Sep. 12, 2019.
(60) Provisional application No. 62/892,514, filed on Aug. 27, 2019.

(51) Int. Cl. G06Q 20/38; G06Q 20/06

(52) U.S. Cl. CPC G06Q 20/3829; G06Q 20/3827; G06Q 20/38215; G06Q 20/065

(57) ABSTRACT

Disclosed herein are methods and systems for creating or providing a blockchain-based digital stable token, facilitating user identification, fund transfer, and payments and trading. The systems and methods provided herein may comprise providing a stable token, a non-stable token, reward rate for payment in the stable token, interest rate for holding the stable token, wherein zero inflation and deflation of the stable token against a weighted average price, such as the PCE price index, can be achieved by constantly optimizing one or more of the i) the reward rate, ii) the interest rate, and iii) the trading between the non-stable token and stable token through a Linear-Quadratic-Gaussian controller.

### CROSS-REFERENCE

This application is a continuation in part of U.S. Provisional Patent Application No. 63/156,231 filed Mar. 3, 2021 and U.S. application Ser. No. 17/680,072, filed Feb. 24, 2022, which is a continuation of International Patent Application No. PCT/US20/48297, filed on Aug. 27, 2020, which claims the benefit of U.S. Provisional Patent Application Nos. 62/892,514, filed Aug. 27, 2019; 62/899,665, filed Sep. 12, 2019; 62/927,595, filed Oct. 29, 2019; 63/053,444, filed Jul. 17, 2020; and 63/055,774, filed Jul. 23, 2020, each of which is entirely incorporated herein by reference.

### BACKGROUND

Digital tokens on blockchain may be transferred from one account to another account. Blockchain is used for eliminating counterfeit tokens. Digital tokens on the same blockchain can be transferred in a decentralized manner, often without a third party. Users may perform various monetary or non-monetary activities or transactions with such digital tokens under aliases, for example, avatars, without revealing a true real-world identity of an individual.

Digital tokens may be useful as a digital currency if the digital currency can maintain sufficiently stable purchasing power, e.g. stable tokens or stable digital currencies. In theory, multiple approaches can create stable digital currencies for daily use. For example, some may implement a Fixed Exchange Rate approach by pegging to fiat currencies, such as the Dollar, Euro, and Yen. Some currencies, such as Libra™, may implement a Fixed Exchange Rate approach by pegging to a basket of weighted fiat currencies, but allowing narrow range floating against individual fiat currencies in the basket. However, such digital currencies derive intrinsic value from fiat currencies issued by central banks, such as the Dollar, Euro, and Yen, which consequentially inherit the 2% annual inflation target of these central banks and, accordingly, result in loss of purchasing power overtime.

Digital tokens can be offered for investment as securities and be traded at exchanges. These investment tokens are non-stable tokens because they fluctuate against stable tokens and fiat currencies. Both stable tokens and non-stable tokens can be traded at exchanges. Stable tokens, e.g. stable digital currencies, can be used to buy non-stable tokens and fiat currencies, and vice versa. The non-stable tokens may also be non-investment securities, even if they fluctuate against stable tokens and fiat currencies.

### SUMMARY

Recognized herein is a need for i) a stable digital token, which has constant purchasing power, e.g. zero inflation and zero deflation against weighted average price index (such as Personal Consumption Expenditures (PCE) Price Index published by the U.S. Department of Commerce or equivalent entities), ii) a trustworthy identity verification platform for users that can accurately verify an identity without revealing unnecessary information about the individuals, parties and the transactions, iii) payments platform connecting payers and payees, and/or person to person payment, through point of sales, and iv) a trading platform (e.g., exchanges platform) for buying and selling among the stable digital currency, non-stable tokens and fiat currencies. Accordingly, the systems and methods described herein include the creation of a stable token without inflation and deflation, verification platform of user's identity, fund transfer, payments and trading by utilizing blockchain networks and smart contracts.

Disclosed herein is a method and system for creating a stable token with zero inflation and zero deflation, compromising i) a stable token, ii) a non-stable investment or non-investment token, iii) reward rate for payment in stable token, iv) interest rate for holding stable token, v) weighted average price index for measuring inflation and deflation of the stable token, such as the Personal Consumption Expenditures (PCE) Price Index published by the U.S. Department of Commerce or equivalence, vi) exchange for trading between the stable token and non-stable token, and vii) a Linear-Quadratic-Gaussian (LQG) controller, wherein the reward rate, the interest rate, and the trading between the non-stable token and the stable token, are constantly and automatically optimized and adjusted, individually or collectively, towards zero inflation and deflation of the stable token. The stable token and non-stable token may be tied together in economics and in governance, because they share the same issuing central entity CryptoFed. For example, certain percentage of newly minted stable token can be dedicated to buying back the non-stable token or paying dividend to non-stable token holders. Non-stable token holders may have rights to create governing rules for the stable tokens.

The main policy tool of money supply of conventional monetary systems (e.g., as managed by central banks) is utilizing the increases and decreases of interest rate (such as the Federal Funds Rate) to adjust lending activities by commercial banks. In contrast, the systems and methods provided herein adjusts money supply through adjusting parameters such as the reward rate paid to consumers, interest rate paid to stable token holders, and the trading between the non-stable token and the stable token, etc. When the LQG controller determines or detects a strong tendency for inflation of the stable token, it can reduce the reward rate and increase the interest rate to discourage spending and encourage savings (e.g., holding the stable token) and can further reduce the stable token money supply by buying back the stable tokens with the non-stable token. When the LQG controller determines or detects a strong tendency for deflation of the stable token, it can increase the reward rate and decrease the interest rate to encourage spending and discourage savings (e.g., holding the stable token) and can further increase the stable token money supply by buying back the non-stable tokens with the stable token.

Because the conventional monetary systems depend on commercial banks' lending activities, over time it leads to a high aggregate debt level at non-financial sectors and results in the loss of additional borrowing ability of non-financial sectors for economic growth even at a very low interest rate (e.g., close to zero), which causes the disfunction of monetary systems. Central banks in the US, EU, UK, and Japan have suffered zero or negative interests for a decade without an effective solution. The present invention overcomes the disfunction by supplying money through rewards paid to consumers rather than lending to them, through interest paid to stable token holders rather than taking interest from them, and through the LQG controller's mathematical calculation and analysis rather than a shot in the dark.

In order to encourage users and merchants to continue to hold the digital currency rather than fiat, the system disclosed herein can provide better interest to all stable token holders than all major fiat currencies, such as US Dollar, Euro, Japanese Yen and British Pound. Because central banks in the US, EU, UK and Japan have suffered zero or negative interests, as long as the interest paid to the stable token holders can be at least 1% higher than Federal Funds Rate, the interest is still very attractive to the stable token holders, and the costs associated with stable token are low and can be absorbed by strong economy growth.

In addition, in an emergent world of multiple currencies within one geographical territory, the merchant community can effectively increase the purchasing power of a stable token through issuance of merchant-issued loyalty, coupons, and rewards tied to the stable token. When a user receives a merchant-specific benefit by transacting with a privately-issued token, the purchasing power of the stable token increases. Merchants can directly benefit from this new blockchain-based mode of rewards and marketing. Instead of paying online advertising entities, the present disclosure offers merchants a capability to deliver incentives directly to interested users without intermediary fees, via blockchain technology. As the stable token user base grows, conventional marketing expenses can be reduced, and these funds (i.e., reduced marketing expenses) can be redistributed directly to the merchant's loyal users through a blockchain-based platform, as described herein. In conjunction with the rewards by the stable token, merchant incentives broadcasted through the blockchain can directly translate into increased purchasing power for the user. Increases in purchasing power gained from the redemption of stable token rewards, merchant loyalty, coupons, and rewards stimulate more economic growth, generate additional demand for the stable token as medium of exchange, and can allow for additional issuance of the stable token.

As a result, the systems and methods disclosed herein can scientifically and directly stimulate economic growth through paying rewards to consumers and interest to stable token holders rather than being paid by them, and through providing free services to merchants rather than charging them, which in turn can generate additional demand for the stable token as a medium of exchange, and can allow for additional issuance of the stable tokens, creating a virtuous cycle and network effect that encourage mass adoption and use of the stable token in preference to other tokens or currencies. In other words, the purchasing power of the stable token can remain stable as the impact of new issuance of the stable token on purchasing power is offset through the increased demand for the currency generated by economic growth, the quantity of which can be determined by the LQG controller's mathematical calculation.

Recognized herein is a need for systems and methods to facilitate digital currencies with stable purchasing power. Provided are blockchain-based platforms for digital currencies configured to provide users with stable purchasing power. Provided are identity verification platforms. Disclosed herein is a method for masking a transaction, comprising providing a first database accessible by a certifier entity, comprising protected data, wherein the protected data is assigned an identifier; and providing a second database, comprising transactional records associated with the identifier, wherein the transactional records are encrypted by (1) a first key corresponding to a private key of the certifier entity and (2) a second key corresponding to a private key of a master avatar associated with the identifier, wherein the second key is managed by the central entity or a user associated with the master avatar, wherein in order to search for the transactional records associated with the identifier, two keys must be provided to the second database. The certifier entity may not have access to the second key. The identifier may be hashed data. The identifier may be verified by both a user assigned to the identifier and the certifier entity. The identifier may be verified first by the user assigned to the identifier and second by the certifier entity.

Disclosed herein is a system for masking a transaction, comprising a first database accessible by a certifier entity, comprising protected data, wherein the protected data is assigned an identifier; and a second database, comprising transactional records associated with the identity identifier, wherein the transactional records are encrypted by (1) a first key corresponding to a private key of the certifier entity and (2) a second key corresponding to a private key of a master avatar associated with the identifier, wherein the second key is managed by the central entity or a user associated with the master avatar, wherein in order to search for the transactional records associated with the identifier, two keys are provided to the second database. The certifier entity may not have access to the second key. The identifier can be hashed data. The identifier can be verified by both a user assigned to the identifier and the certifier entity.

Disclosed herein is a method for facilitating payment, comprising receiving, at a server in communication with a central entity, from a user device of a first user, a selection of a digital token transfer method to a second user; processing said digital token transfer method, by said server, by initiating a transfer of digital tokens from a digital account of said first user to a digital account of said central entity and substantially simultaneously initiating a transfer of a same amount of said digital tokens from said central entity to an account of said second user; and receiving, at a server in communication with said central entity, from a second device of said second user a request to issue an incentive amount of digital tokens to said first user and substantially simultaneously initiate a transfer of said digital tokens of the same incentive amount from said account of said second user to said first user. The central entity can receive verification of an identity of the first user and an identity of the second user. The method can further comprise, prior to (a), initiating a transfer of fiat currency from a financial institution account of said first user to a financial institution of said central entity, and substantially simultaneously initiating a transfer of digital tokens from said central entity to an account of said first user. The initiating can be performed on a web-based interface. The initiating can be performed on a mobile-web interface. The method can further comprise receiving a selection of a digital token transfer to the second user and a third user simultaneously.

Disclosed herein is a system for facilitating payment, comprising a server in communication with a blockchain network and a central entity, wherein the server comprises one or more processors, individually or collectively, configured to receive from a first user device of a first user, a selection of a digital token transfer method to a second user; process said digital token transfer method, by said server, by initiating a transfer of digital tokens from a digital account of said first user to a digital account of said central entity on said blockchain and substantially simultaneously initiating a transfer of a same amount of said digital tokens from said central entity to an account of said second user; and receive, at a server in communication with said central entity, from a second device of said second user a request to issue a reward amount of digital tokens to said first user and substantially simultaneously initiating a transfer of said digital tokens of a same reward amount from said account of said second user to said first user. The central entity can receive verification of an identify of the first user and an identity of the second user. The one or more processors can be, individually or collectively, further configured to, receive fund transfer initiation from the first user to the second user. The one or more processors can be, individually or collectively, further configured to, provide a mobile-based interface for the fund transfer initiation to the user device.

Disclosed herein is a system for facilitating payment, comprising a server in communication with a blockchain network and a central entity, wherein the server comprises one or more processors, individually or collectively, configured to receive from a first user device of a first user, a selection of a digital token transfer method to a second user; process said digital token transfer method, by said server, by initiating a transfer of digital tokens from a digital account of said first user to a digital account of said second user on said blockchain without said central entity; and receive, at a server in communication with said central entity, from a second device of said second user a request to issue a reward amount of digital tokens to said first user and substantially simultaneously initiating a transfer of said digital tokens of a predetermined percentage reward amount from account of said central entity to said first user. Substantially and simultaneously at the second user's own discretion, said second user can also issue and transfer the second user's own brand specific reward digital tokens to the said first user without central entity which is only redeemable at the said second user. The central entity can receive verification of an identify of the first user and an identity of the second user. The one or more processors can be, individually or collectively, further configured to, receive fund transfer initiation from the first user to the second user. The one or more processors can be, individually or collectively, further configured to, provide a mobile-based interface for the fund transfer initiation to the user device.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an example of a transaction flow with a blockchain network for fiat currency exchange to digital token.

FIG. 2 illustrates another example of a transaction flow with a blockchain network involving purchase with digital tokens.

FIG. 3 shows a process flow for digital token exchange to fiat currency.

FIG. 4 is a diagram illustrating a virtuous cycle as described herein.

FIG. 5 is a diagram illustrating the creation and use of a global blockchain identity avatar.

FIG. 6 is a diagram illustrating the predefined attributes of subset avatars of a master avatar.

FIG. 7 is a diagram illustrating the relationship between different blockchain currencies to the virtuous cycle.

FIG. 8 is a diagram illustrating the merchant incentive campaigns via the central entity blockchain broadcasting services.

FIG. 9 is a diagram illustrating the users broadcast needs to search for merchants via the central entity blockchain broadcasting services.

FIG. 10 illustrates a closed-loop market that allows for transactions between users.

FIGS. 11A and 11B illustrate the transfer of preferred stock within a preferred stock exchange and within in-network exchanges.

FIG. 12 is a graph of a virtuous cycle as described herein showing the difference between a network effect in traditional credit systems, which is linear, compared to a token system, in which the network creates a curve that will cover the cost of the system due to the user-to-user communication and transaction capability which rewards to consumers with every transaction.

FIG. 13 is a diagram outlining the creation of a user avatar.

FIG. 14 is a diagram outlining an example of the verification of a user's identity.

FIG. 15 is a diagram outlining the use of a master avatar

FIG. 16 is a diagram of an encryption process provided by the central entity database and the certifier database to protect a user's identify and token exchange history.

FIG. 17 is a diagram illustrating an interaction between a merchant and a user through an avatar.

FIG. 18 is a diagram illustrating the logging of purchase transactions on the central entity's blockchain.

FIG. 19 is a diagram of the logging of non-purchase transactions on the central entity's blockchain.

FIG. 20 is a diagram of a process of encryption of purchase and non-purchase transactions.

FIG. 21 is a diagram of a process of encryption of purchase transactions using a one time public address and a masked amount.

FIG. 22 is a diagram of a key management system.

FIG. 23 is a diagram of the interaction of different subsystems of the token exchange system.

FIG. 24 is a diagram illustrating an example of token exchange.

FIG. 25 is a diagram illustrating an example of a retail payment using token exchange.

FIG. 26 is a diagram illustrating the differences between the monetary system of the present invention and existing central banks.

FIG. 27 is a diagram illustrating the LQG controller's optimal process for achieving zero inflation and deflation.

FIG. 28 is a diagram illustrating the construction of a report of average price levels (and possibly other quantities) from a transaction bundle (transactions collected from several verified blocks on the blockchain).

FIG. 29A, FIG. 29B and FIG. 29C are diagrams illustrating the flow of data as it is collected from the blockchain, used for report creation, and policy (interest, rewards, Governance Tokens to buy/sell during some period) creation and enforcement.

FIG. 30 is a diagram illustrating the calibration of the LQG controller and policies generation.

FIG. 31 shows a diagram illustrating a sequence for consumer flow.

FIG. 32 shows a diagram illustrating a sequence for merchant flow.

FIG. 33 shows a diagram illustrating a sequence for in-person payment.

FIG. 34 shows a diagram illustrating a sequence for an exemplary gas payment.

FIG. 35 shows a diagram illustrating a sequence for an exemplary gas payment.

FIG. 36 shows a diagram illustrating a sequence for an exemplary gas payment.

FIG. 37 shows a diagram illustrating a sequence for an exemplary online/web payment.

FIG. 38 shows a diagram illustrating a sequence for an exemplary online/web payment.

FIG. 39 shows a diagram illustrating an exemplary issuing entity exchange flow.

FIG. 40 shows a diagram illustrating an exemplary issuing entity exchange flow.

### DETAILED DESCRIPTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

Electronic fund transfers require complying with laws and regulations, such as Know Your Customers (KYC) and Anti-Money Laundering (AML). That is, oftentimes, prior to initiating fund transfers through a digital currency, an identity of the true and real person, both natural and legal, must be established to meet the requirements of the laws and regulations. Therefore, provided herein are systems and methods for establishment and management of a universal digital identities for a plurality of users which can be used globally with a blockchain-based digital currency. The methods and systems for digital identity management may preserve privacy and mask transaction information, while only disclosing necessary information to the intended parties as needed. In some cases, entities which already have possession of identity information in the course of ordinary business, such as government agencies issuing driver license, banks, credit unions, insurance companies, universities, airlines, etc. can serve as digital identity certifiers for the digital identity on the blockchain and provide digital wallets for transactions on the blockchain. New entities may become digital identity certifiers. In the systems and methods provided herein, a central entity independent of the digital identity certifiers may be configured to manage the private keys of the digital wallets, such that the digital identity certifiers know and are able to certify the identities of the individuals, but are precluded from accessing transaction information. The segregation of the digital identity certifiers and the manager of the private keys of the digital wallets can ensure that activities on the blockchain are anonymous while achieving accurate identity verification. When an activity on the blockchain needs to be traced back to the true and real individual, the central entity managing the private key of the digital wallet can send a request to the digital identity certifiers based on predetermined criteria (e.g., presentation of court order). Transaction information, such as the sender, the receiver, and the amount, can be masked to preserve privacy.

With digital wallets provided by their digital identity certifiers, users can purchase digital currency from an issuing entity with fiat through regular fiat electronic payment methods, such as credit card, debit card, ACH, etc. The exchange rate between the digital currency and fiat can start from a fixed exchange rate and move to a floating exchange rate with increasing adoption and ubiquity. At the stage of a floating exchange rate, a user has the option to sell the digital currency at compliant exchanges. At the early stage of the fixed exchange rate, users can only use the digital currency to buy goods and services. In order to encourage adoption and stimulate economic growth, the issuing entity (i.e., central entity, CryptoFed) of the monetary system provides a large amount of giveaway for every transaction with a merchant. At the merchants' discretion, the merchant can convert the digital currency to fiat. Notice that “giveaway”, “rewards” and “incentive” are used interchangeably in this specification.

A merchant community can increase the purchasing power of digital tokens through the issuance of merchant-issued loyalty/coupons/rewards (e.g., incentives) that are tied to the digital tokens. When a user receives an added merchant incentive by transacting with a digital token, the purchasing power of the digital token increases. The merchant can benefit from delivering the incentive directly to interested users without fees via a native blockchain broadcasting feature, instead of paying third party advertisers, such as a cost per click or impression. As the digital currency user base grows, conventional marketing expenses are reduced, and these funds can be redistributed directly to the merchant's proven or prospective customers through blockchain-based broadcasting platforms disclosed herein. The aggregate increase in purchasing power gained from the redemption of participating merchant incentives and the issuing entity's giveaway can create additional demand for the digital currency. The digital currency's purchasing power may remain stable even as new tokens are minted to meet that demand due to transaction volume increases caused by the aggregate increased value added by the merchant incentives and the issuing entity's giveaway. Competition among merchants to attract and retain users can also ensure the merchant incentives remain at the necessary level. In addition to loyalty/coupons/rewards, merchants and other entities can also issue their own currencies in the denomination of the stable token or digital currency issued by the central entity (e.g., CryptoFed). This merchant-issued currency can be used in multiple merchants.

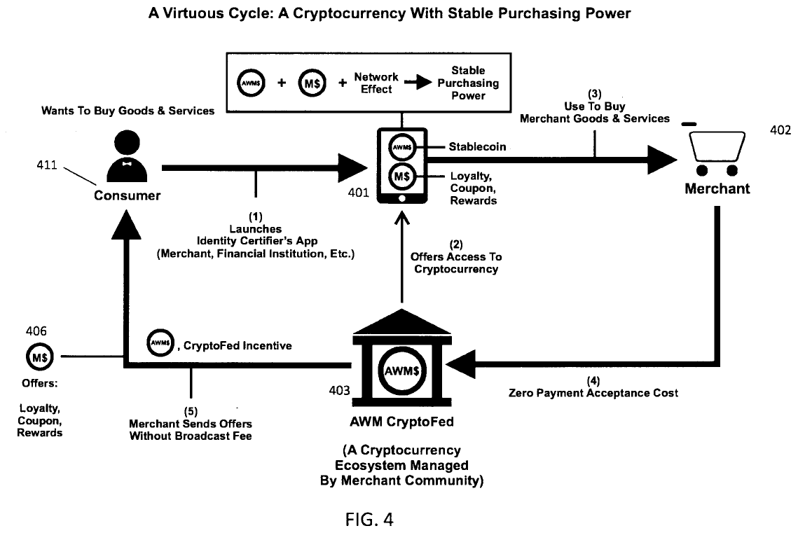

A newly minted digital currency that is generated as a result of increased demand will be used to cover the maintenance and operation costs of the digital currency token economy, making it possible for the network to provide zero cost payment acceptance for merchants. This enables a new zero cost advertising platform for broadcasting merchant incentives and monetary system's giveaway. Merchant benefits and user incentives can work synergistically, creating a virtuous and self-sustainable cycle that encourages mass adoption and use of the digital currency in preference to other competing currencies, leading to the increase of transaction volume and network effect which creates more demand of the digital currency. This virtuous cycle is showcased and described in FIG. 4, for example. Once mass adoption of the digital currency is reached, merchants can hold and use the digital currency as a medium of exchange, viable for accounting and stored value, with low conversion risk to competing currencies. The digital currency ecosystem may comprise digital tokens and digital reward tokens. In some instances, digital tokens may be accepted by all participating merchants, while digital reward tokens may only be redeemed at issuing merchants as a merchant-specific white-labeled token.

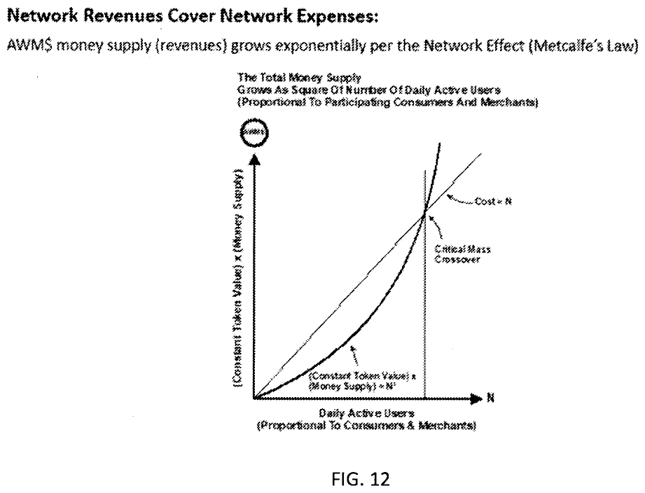

Network effect of the digital currency will be created with mass adoption by merchants and consumers, which means that the increased usage of the digital currency leads to a direct increase in the value of the digital currency to its users. A digital currency without acceptance by merchants and consumers will be useless. Its value depends on the acceptance by others and increases with the number of connections to others. Monetary system's giveaway, merchant incentive, zero cost payment acceptance and zero cost advertising platform all will generate more and more usage of the digital currency, which in turn will create more and more acceptance and connections among consumers and merchants. The increased connections can lead to more and more purchase and non-purchase activities, P2P, B2B, identity verification, customer review, opinion posting and eventually result in increased demand of the digital currency. To the extent that non-purchase activities also lead to the increases of users, it will ultimately contribute to purchase activities and the increased demand of the digital currency. The monetary system's value may be expressed in a modified Metcalfe's law, FIG. 12, which can be used to guide money supply. The monetary system's giveaway, the largest portion of system cost, is based on per purchase transaction, which is a linear function, while the monetary system's value, per Metcalfe's law, will grow as the square of the number of active users and their activities. With the increases of users and activities, the monetary system's value is expected to follow Metcalfe's law, grow exponentially and surpass the cost to maintain the system. In order to apply Metcalfe's law, in addition to providing giveaway, the monetary system can be configured not to charge fees for activities, nor create barriers for activities. The monetary system can remove all potential monetary and non-monetary barriers and transaction costs for purchase and non-purchase activities between and among users to fully take advantage of the network effects of the digital currency. As each new member increases the number of potential connections available to all other members, the value of each member keeps rising as the network expands. This relationship is captured in Metcalfe's Law, which states that the value of a one-to-one network grows in proportion to the square of the number of user. If the number of network members equals n, in other words, the value of a one-to-many network grows in proportion to n while the value of a one-to-one network grows in proportion to n². In another example, known as Reed's law, if you add up all the potential two-person groups, three-person groups, etc., the number of possible groups equals 2ⁿ. In such a case, the value of a GFN can increase exponentially, in proportion to 2ⁿ.

Network effect, measured by either Metcalfe's law or Reed's law, can provide guidance for minting new digital currency to meet the demand. In theory, when money supply follows Metcalfe's law or Reed's law, there should be no inflation and deflation, because the additional money supply is minted for the demand of the digital currency. In practice, however, there may be needs to use the digital currency for stored value which will be taken out of circulation. The digital currency may be converted to other currencies. Economic shocks in other currencies may have impact on needs of the digital currency. In order to absorb these unexpected fluctuations of demand of the digital currency, in addition to MetCalfe's law or Reed's law, monetary system needs policy tools to adjust money supply to ensure that the digital currency can peg to the PCE price index with zero inflation and deflation. The monetary system's central entity (i.e., issuing entity, CryptoFed) can adjust the giveaway percentage between 6.5%-16% which is equivalent to the fiscal policy of the monetary system. Ideally, the giveaway will not be lower than 6.5% so that the monetary system can constantly stimulate economic growth. The central entity (i.e., issuing entity, CryptoFed) can also adjust interest paid to all the holders of the digital currency which can shift preferences to hold or spend the digital currency, which is equivalent to the monetary policy. The interest paid to the digital currency holders can be at least 1% higher than Federal Funds Rate in order to encourage users to hold the digital currency rather than US dollar. The central entity can also use the monetary system's preferred stock (bond) to buy the digital currency and take the digital currency out of circulation if the central entity anticipates inflation per the PCE price index. The terms “American World Money,” “American CryptoFed,” and “CryptoFed” are used interchangeably herein and generally referred to a central entity. A conventional monetary system has to maintain a mass number of commercial banks and branches to keep money into circulation, while the present disclosure leverages retail merchants' existing operations. To this extent, the overhead costs of the present disclosure are much less than the conventional monetary system.

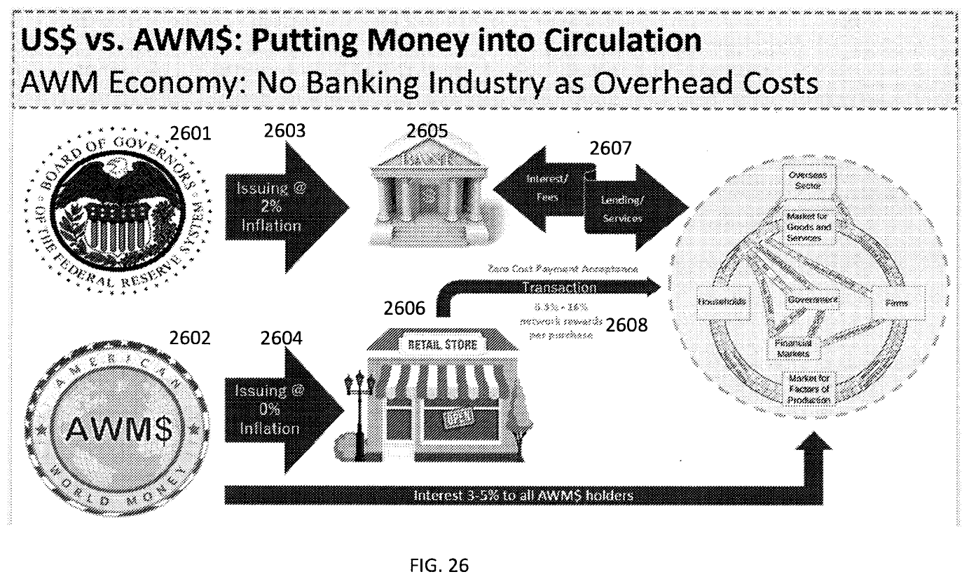

FIG. 26 illustrates the difference between the monetary system according to the present disclosure and the conventional monetary systems (e.g., central banks). In a conventional monetary system, a central bank 2601 may issue 2603 fiat currencies based on a certain inflation rate (e.g., 2%). Commercial banks 2605 conduct their lending activities 2607 by charging the borrowing entities interests plus fees associated with the lending activities. These banking overheads cost the economy not only on the merchant's side, but also on the consumer's side by way of transferring cost. In contrast, under the systems and methods provided herein, a central entity 2602 (e.g., “AWM”) may issue 2604 tokens (e.g., stable tokens) based on an assumption that it generates 0% inflation. Merchants 2606 (e.g., retail stores, service providers, etc.) may receive the tokens and circulate them in the economy, with zero cost in terms of receiving the token. This reduces and sometime eliminates the banking overheads. Merchants 2606 may then circulate 2608 the tokens in the economy while allowing network rewards to be issued to consumers based on purchase transactions. By paying rewards to consumers, and paying interests to token holders, the monetary system regulated and controlled by the systems and methods disclosed herein can directly stimulate economic growth. This may in turn generate more demand for stable tokens as a medium for exchange, and can allow for additional issuance of the tokens.

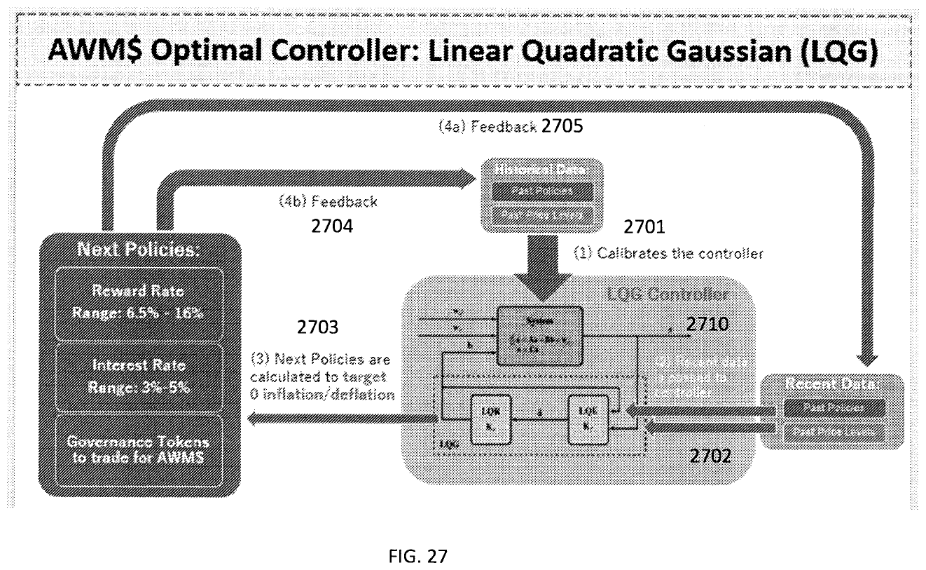

FIG. 27 illustrates using a LQG controller to achieve zero inflation and deflation in the monetary system according to the present subject matter. The LQC controller 2710 may receive 2701 historical data and recent data 2702. The historical data may include past policies (e.g., reward rate, reward rate range, interest rate, interest rate range, exchange rate between stable token and non-stable token, exchange rate between fiat currencies and stable token, etc.) and past price levels (e.g., merchant-specific price levels). The recent data may include past policies and past price levels. The LQG controller 2710 may calculate 2703 the next policies based on the historical data and recent data to target a zero inflation and deflation rate. For example, when the LQG controller 2710 detects a strong tendency for inflation of the stable token, it calculates/determines 2703 that the next policies are to reduce the reward rate and increases the interest rate to discourage spending and encourage savings (holding the stable token), and can further reduce the stable token money supply by buying back the stable tokens with the non-stable token. When the LQG controller 2710 detects a strong tendency for deflation of the stable token, it calculates/determines 2703 that the next policies are to increase the reward rate and decrease the interest rate to encourage spending and discourage savings (holding the stable token), and can further increase the stable token money supply by buying back the non-stable tokens with the stable token. These policies are stored 2704 to the historical data set (e.g., historical data 2701). In some embodiments, these policies replace 2705 the recent data set (e.g., recent data 2702) as they are more recent than the previously-stored recent data. Alternatively or additionally, the recent data set may include the past one (1) set of policies, two (2) sets of policies, three (3) sets of policies, or five (5), ten (10), fifteen (15) sets of policies, etc. By utilizing the LQG controller 2710, the monetary system according to the present subject matter may calculate and implement a set of policies that ensures a zero inflation and deflation rate, and thus provide a stable purchasing power of the stable tokens. As described with respect to FIG. 27, by leveraging input data from the historical data and the recent data, the LQG controller may operate on a feedback loop(s) to ensure and maintain the target inflation or deflation rate (e.g., 0%). In some instances, components of the next policies may be implemented at different frequencies, such that the interest rate is updated in a next policy at a first frequency, the reward rate is updated in a next policy at a second frequency, and the trading of tokens is updated in a next policy at a third frequency, where the first, second, and third frequencies may be the same or different. In some cases, the three parameters above may be updated in a single next policy or as multiple separate policies.

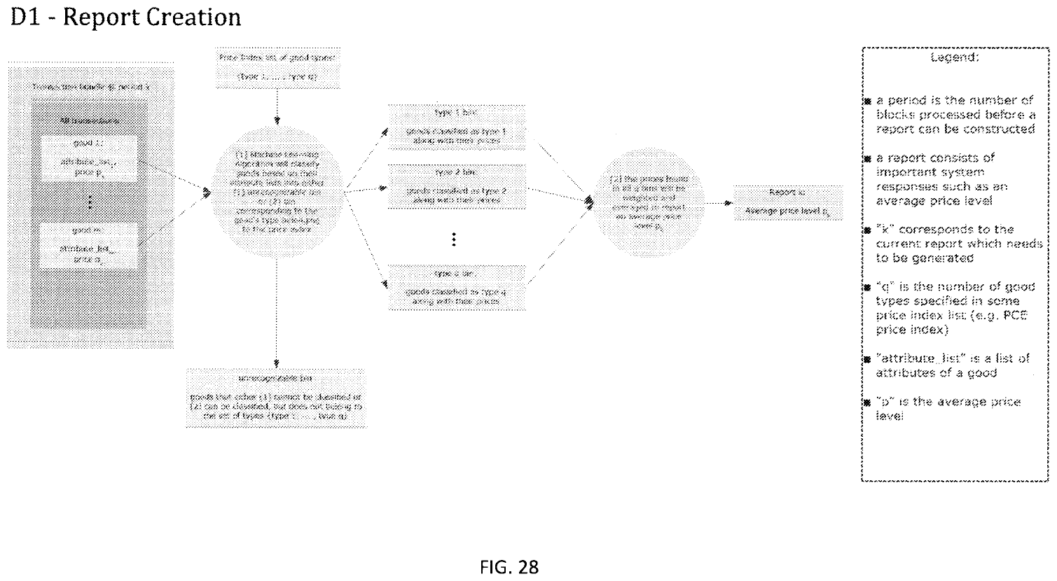

FIG. 28 shows the construction of a report of average price levels (and other quantities) from a transaction bundle (transactions collected from one or more verified blocks on the blockchain). Transactions in the transaction bundle are comprised of goods and their settled prices. For example, a transaction bundle at period k may comprise a plurality of transactions for goods 1 to m. Period is the number of blocks processed before a report can be constructed. Each transaction for a good n may comprise attribute data (“attribute_listₙ”) and price data (“price pₙ”). At classification, one or more machine learning algorithms may intake data for a price index list of good types (“type 1, type 2, . . . type q”), as well as the transaction data, and classify the goods to either (1) an unrecognizable bin, or (2) corresponding type bin, belonging to the price index list. Number “q” is the number of good types specified in some price index list (e.g., PCE price index). The unrecognizable bin receives, from the classification module, a good that is either (1) cannot be classified, or (2) can be classified but does not belong to the good types (“type 1, type 2, . . . type q”) of the price index list. Each of the classified goods is placed into one of the corresponding type bin along with their prices. Next, the prices stored in the corresponding bins (e.g., q bins in this embodiments) are weighted and averaged to report an average price level pₖ, wherein number “k” corresponds to the current reports that needs to be generated. The generated report k may reflect the average price level pₖ, wherein “p” is the average price level. The generated report comprises important system response such as an average price level. In some embodiments, this average price level constitutes the report issued per each transaction bundle.

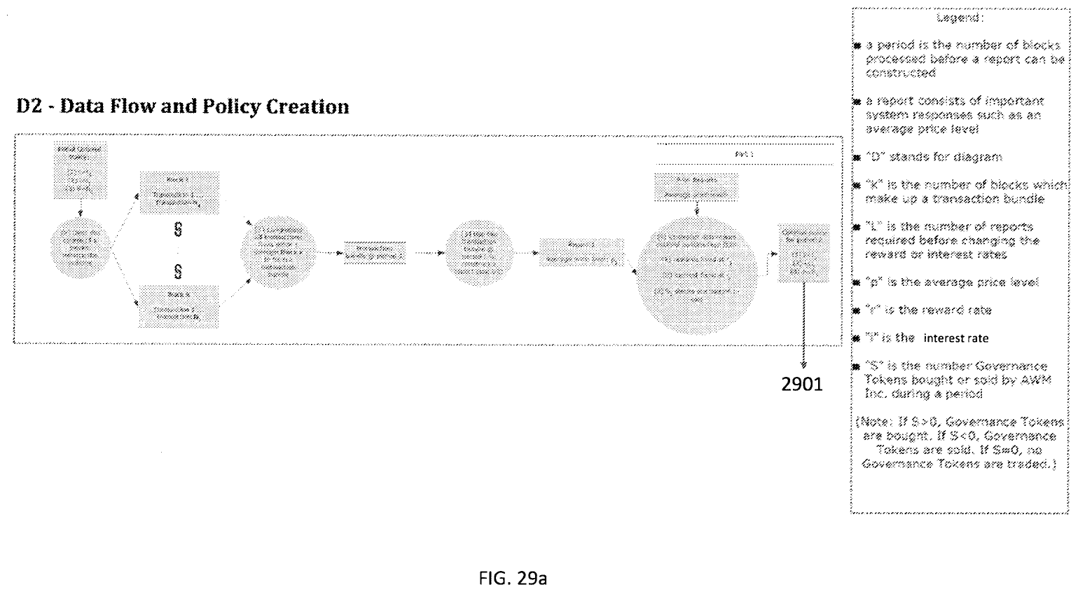

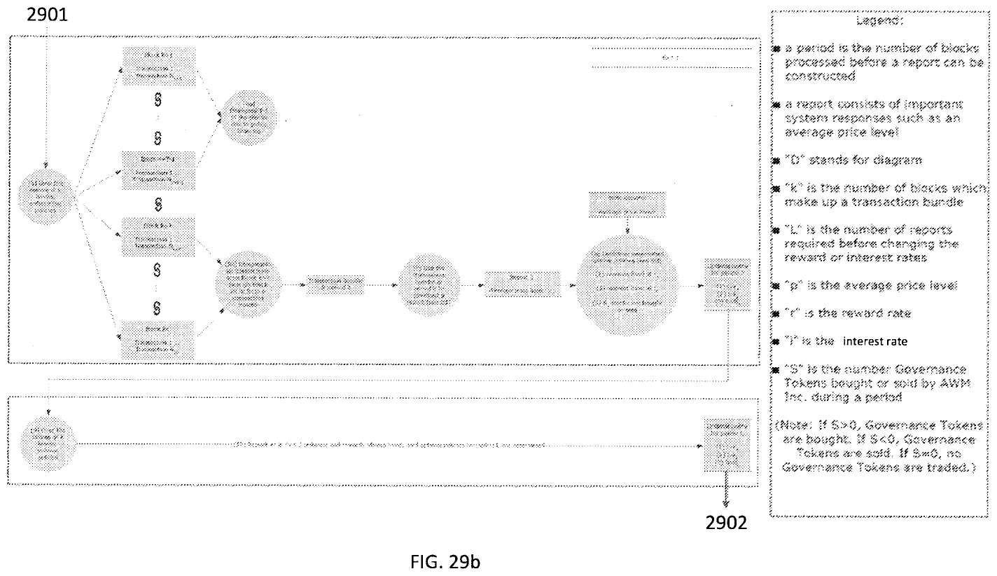

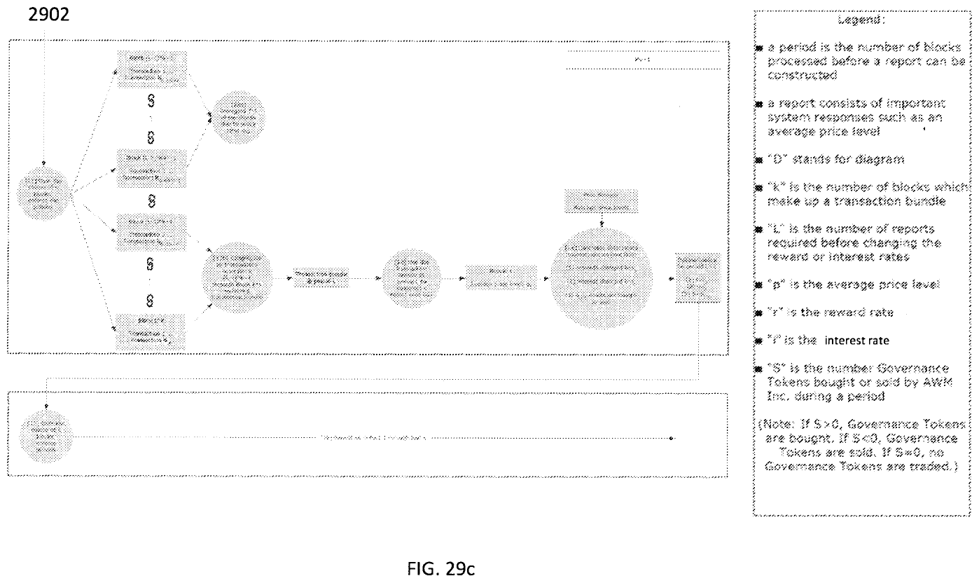

FIGS. 29a-c shows the flow of data as it is collected from the blockchain, used for report creation, and ultimately optimal policy (interest, rewards, Governance Tokens to buy/sell during some periods) creation and enforcement. A policy is enforced and fixed over the course of some blocks. For example, as shown in FIG. 29a, an initial optimal policy for period 1 is enforced over the course of k blocks, wherein the initial optimal policy for period 1 comprises r₁, i₁, and S₁, and k is the number of blocks which make up a transaction bundle. The indicator r is the reward rate, i is the interest rate, and S is the number of governance tokens bought or sold by central entity during n period. If S>0, the governance tokens are bought, and if S<0, the governance tokens are sold. If S=0, no governance tokens are traded. In some embodiments, the blocks (e.g., blocks 1 to k) each comprises a number of transactions, for example, block 1 comprises transaction 1 to N₁, block k comprises transaction 1 to Nₖ. In congregation, all the transactions from the blocks 1 to k are congregated to form a transaction bundle. From this transaction bundle, a current report is issued via D1 (as shown in FIG. 28). Prior reports and policies are used to calibrate the LQG controller. The calibrated LQG controller then uses the current report, which comprises an average price level p₁, and current policy to determine or construct an optimal policy which maintains a fixed average price level (0 inflation). This optimal policy is then enforced over the course of some blocks and the process is repeated as needed, or contentiously, or based on a predefined schedule, as shown in FIGS. 29b and 29c. The generated optimal policy for period 2 (shown in FIG. 29a) is transmitted 2901 to be enforced over the course of k blocks in FIG. 29b. The systems and methods provided herein repeat the steps depicted in FIG. 29a to determine the next optimal policy for period 3. The difference is that a number of blocks may be disregarded dur to policy time leg. Next, the systems and methods provided herein repeat the steps depicted in FIG. 29a for a L times, wherein L is the number of reports required before changing the reward or interest rate. The determined optimal policy for period L is transmitted 2902 to be enforced over the course of k blocks in FIG. 29c. The systems and methods provided herein repeat this process to maintain a zero(0) inflation of the digital tokens.

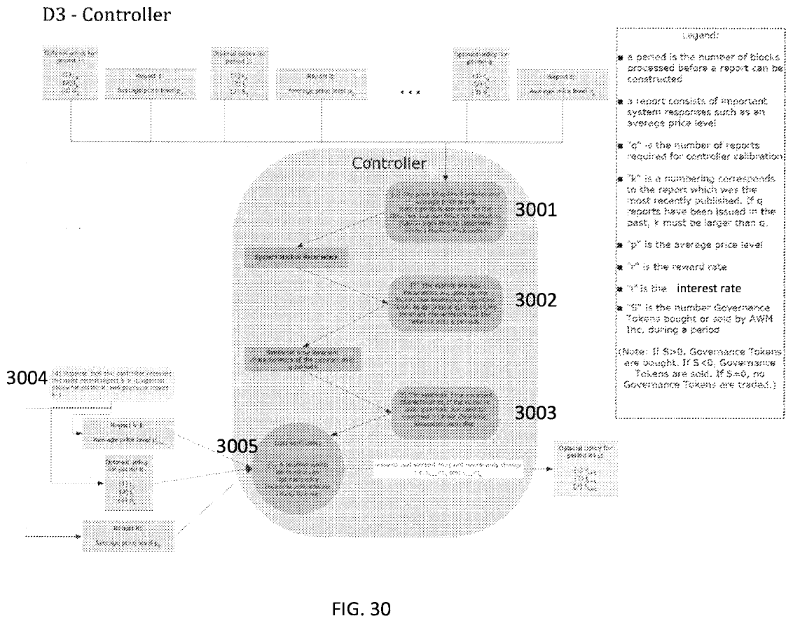

FIG. 30 shows how historical reports are used to calibrate the LQG controller and how new policies are determined based at least in part on recent reports. Historical reports (e.g., report 1 to report q, wherein “q” is the number of reports required for controller calibration) coupled with historical policies (e.g., optimal policy for period 1 to period q, wherein each of the report comprises r, i, and S, r is the reward rate, i is the interest rate, and S is the number of governance tokens bought or sold by central entity during n period) are used by the Observer Kalman Filter Identification (OKID) algorithm to determine 3001 System Markov parameters. In some embodiments, the pairs of average price levels and the optimal policies over a period of time are used by the OKID algorithm to determine the System Markov parameters. The System Markov parameters are then used by the Eigen Realization Algorithm (ERA) to determine 3002 synthetic time invariant characteristics of the economy (e.g., one characteristic is a linear mapping which describes the effects optimal policies have on the average price levels). The determined synthetic time invariant characteristics of the network over q period may be used to construct (e.g., calibrate) 3003 the LQG controller. Current reports and current policies are then received 3004 at the LQG controller and processed 3005 by the LQG controller to determine an optimal policy to enforce over some number of blocks. For example, the LQG controller may receive 3004 a most recent report k, and k is a number greater than q. This is because “k” is a number corresponds to the most recent report, thus if “q” reports have been issued in the past, k must be greater than q. When the LQG controller receives the most recent report k, it may extract the optimal policy for period k, and previous report k−1. The previous report k−1 may comprise an average price level pₖ₋₁. The optimal policy for period k may include rₖ, iₖ, and Sₖ. The report k may comprise an average price level pₖ. The LQC controller may intake the previous report k−1, the optimal policy for period k, and the report k and determine 3005 an optimal policy (e.g., rewards and interest rate) to issue. The rewards and interest rate of this k+1 period does not necessarily be different than the previous one, i.e., the ones for the period k. The determined optimal policy for period k+1 comprises r_{k+q}, iₖ₊₁, and Sₖ₊₁.

The systems and methods described herein may facilitate fund transfer by utilizing blockchain networks, digitized financial credit, and/or blockchain-based broadcasting. The systems and methods may support any type of transfer, including, for example, an external funds transfer, person-to-person (P2P) transfer, business-to-business (B2B) transfer, purchase at a point of sale (POS), international remittance, online banking payment, government payment or disbursement, mortgage or bill payment, direct deposit or other type of fund transfer or payment.

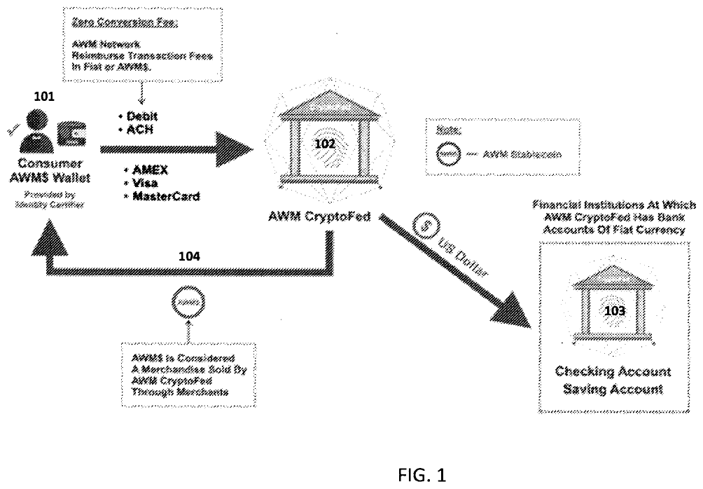

FIG. 1 illustrates an example of a transaction flow with a blockchain network involving fiat currency and digital token exchange. A user 101 (e.g., consumer) may use a user device and may initiate a purchase of tokens 104 from a central entity fund transfer system 102 for example using fiat currency. The fund transfer system 102 can comprise and/or be in communication with a blockchain network. The fund transfer system can be the central entity. The central entity as described herein can be interchangeably be described as the issuing entity or the CryptoFed. The central entity can be in communication with a checking or savings account of fiat currency 103, to which the user's payment (of fiat currency) is transferred. The communication between the user 101 and the fund transfer system 102 can include the user of graphical codes (e.g., quick response (QR) codes). The descriptions herein can apply to a point of sale system in a physical retail shop or ecommerce online shopping system. In some embodiments the user 101 may be engaging in a point of sale system in a retail shop or a shopping card web page on an Internet site (e.g., using a web-based interface). CryptoFed can also accept cryptocurrencies for stable token purchase, which will not involve fiat depository financial institutions, such as banks.

In some instances, the incentive is a digital reward token. In some instances the digital reward token is only redeemable in a transaction between any user and the second user that initiated the transfer of digital tokens from the second user to the first user. In some instances, the digital reward token is only redeemable in a transaction between the first user and the second user that initiated the transfer of digital tokens from the second user to the first user. In some instances the second user is a merchant. In some instances the first user is a merchant. In some instances the second user is a consumer.

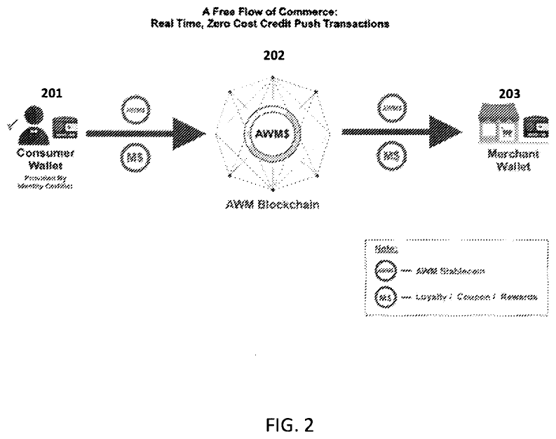

FIG. 2 illustrates the transfer of tokens from a user account 201 to a merchant account 203 through a central entity 202. Upon receipt of approval instructions from the user, the server can request a transfer of funds from a customer account to a merchant account by (i) transferring, in the blockchain network, digital tokens (i.e., AWM$) and/or reward tokens (i.e., M$) from the first user's digital account (e.g., digital wallet) to a digital account of a central entity, (ii) instructing the blockchain network to transfer a digital token amount and reward token amount from the first user's account to a second user's (merchant's) account. There can be multiple blockchain processors to verify the transaction. The transaction can be a direct user to user type, for example from a user's wallet to a merchant's wallet without transferring through a central entity's account.

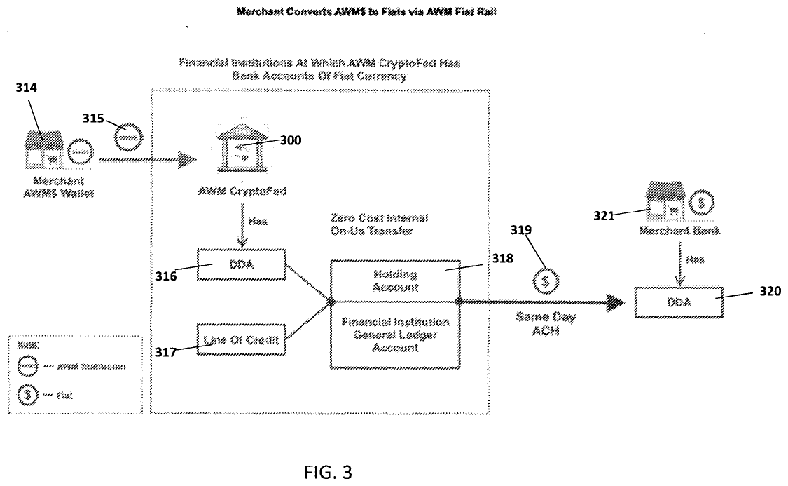

FIG. 3 illustrates a process flow for digital token exchange to fiat currency. A merchant 314 can request an exchange of digital currency 315 to fiat currency 319 from a central entity 300. The central entity 300 receives the request and transfers fiat currency 319 equivalent in value to the digital currency 315 from a central entity's direct deposit account (DDA) 316 and/or line of credit 317 with a financial institution of the central entity to a holding account 318. The fiat currency 319 is then transferred to a direct deposit account (DDA) 320 of the merchant 314, at the merchant's financial institution (FI) 321.

In some embodiments, the invoice may be provided from the merchant to the customer without a QR code. The customer can scan the invoice without the QR code with an optical sensor (e.g., camera) on a user device. The optical sensor can, in conjunction with one or more OCR algorithms, read and recognize text and/or numbers from the invoice. Based on such reading and recognition, the server can identify the information needed for processing payment and automatically present such information to the customer, such as on a graphical user interface, for verification. In some instances, to aid accuracy of the one or more OCR algorithms, the server can provide an invoice template to the merchant. Alternatively or in addition, a merchant can provide an invoice template to the server. The one or more OCR algorithms can then be tailored to accurately recognize certain information from the invoice template (e.g., coordinate location of information relative to boundaries of an invoice). In some embodiments, QR codes can be pre-generated for goods or services (for sale).

Any and all communications between the customer, fund transfer server, and/or merchant can be electronic (e.g., via electronic mail, via server user interface, etc.) or non-electronic (e.g., physically delivered, physically communicated). The customer and the merchant can be in the vicinity of each other (e.g., in same store, same restaurant, same gas station, etc.). The customer and merchant can be remote from each other. Verification of the digital identity of a user (e.g., AWMeID) is performed electronically as described herein. The descriptions herein can apply to a point of sale system in a physical retail shop or ecommerce online shopping system.

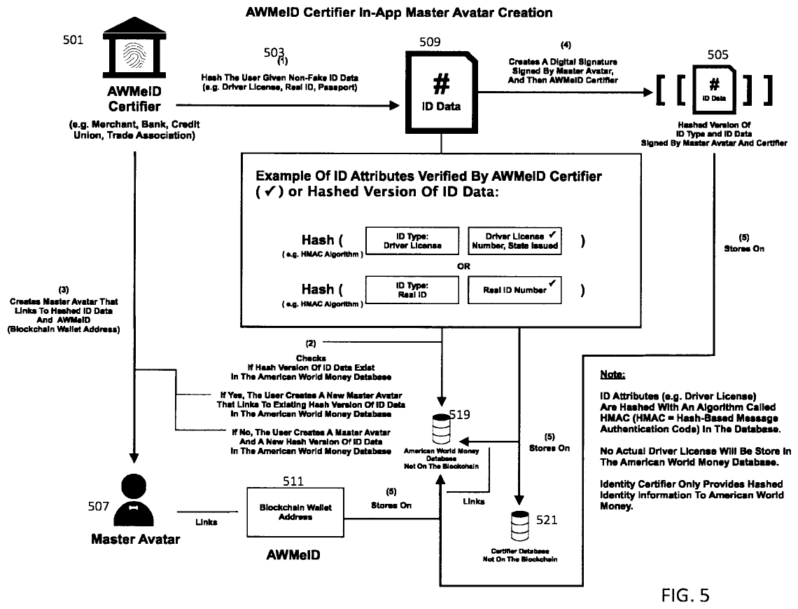

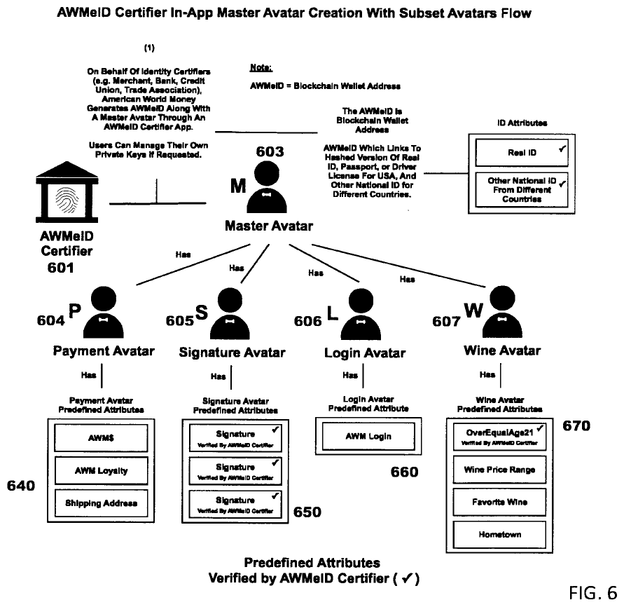

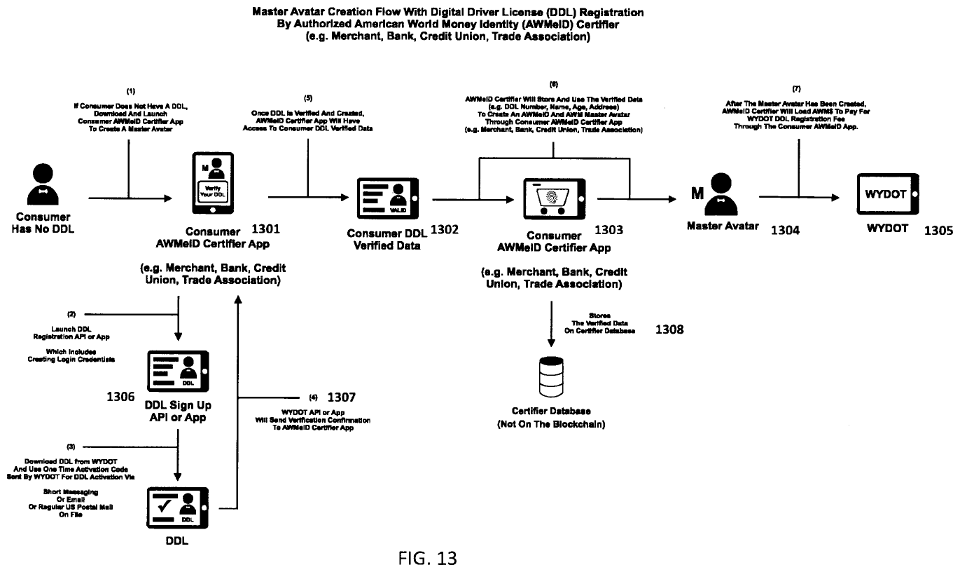

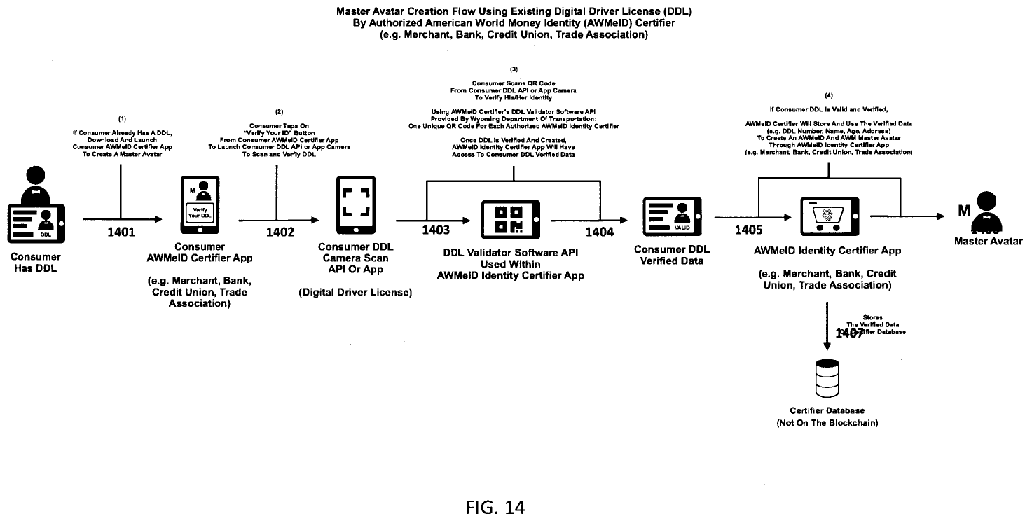

FIG. 4 illustrates a purchase transaction flow with a blockchain network involving digital token exchange. A first user (e.g., consumer) may use the user account 401 to initiate a fund transfer between the first user and a second user (e.g., merchant) through a central entity 403. The first user can receive digital tokens through the central entity 403, for example as described in FIG. 1, or through a second user such as a merchant, for example in a prior transaction 406. A user 411 may have a user account 401 wherein the identity of the user 411 is verified, such as by the systems and methods described with respect to FIG. 13, FIG. 14, FIG. 5 and FIG. 6. The user may use a user device to initiate a request to transfer digital tokens and/or digital token rewards 406 from a user account 401 to a merchant account 402 in exchange for goods and/or services. Upon the completion of the transaction, the merchant account may then use a user device to make a request to a central entity 403 to issue digital token rewards 406 to users for the transaction. Generic token rewards can be used and accepted across the network. The merchant account may also issue loyalty tokens, coupon tokens, and reward tokens to the first user by issuing tokens specific for use with the merchant. The payment acceptance costs for the merchant can be free. Both merchants and users can benefit for the transaction leading to a virtuous cycle. As a result, more and more users and merchants will participate in the network and create a network effect of Metcalfe's law or Reed's law.

A user can be a consumer, a merchant, a transferor, a transferee, a sender, a recipient, and/or any party to a fund transfer or other financial transaction. A user can be an individual or entity capable of legally owning financial property, such as an account, with financial institutions. A user can be an individual or entity capable of owning property, such as money. A user can be an individual or entity capable of depositing, withdrawing, entrusting, and/or storing, such property with financial institutions. For example, a user can be a legal entity (e.g., corporation, partnership, company, LLC, LLLC, etc.). A user can be a government or government entity. A user can be an individual or entity capable of initiating, sending, receiving, and/or approving a financial transfer or financial transaction.

The user devices may be an electronic device. For example, the user devices may each be a mobile device (e.g., smartphone, tablet, pager, personal digital assistant (PDA)), a computer (e.g., laptop computer, desktop computer, server), and/or a wearable device (e.g., smartwatches). A user device can also include any other media content player, for example, a set-top box, a television set, a video game system, or any electronic device capable of providing or rendering data. For example, a user device can be a credit card processing machine or card reader. The user device may optionally be portable. The user device may be handheld. The user device may be a network device capable of connecting to a network, such as described previously, or other networks such as a local area network (LAN), wide area network (WAN) such as the Internet, intranet, extranet, a telecommunications network, a data network, and/or any other type of network. The user device may also be a hardware device designed specifically for identity functionality like that of a card key.

A user device may each comprise memory storage units which may comprise non-transitory computer readable medium comprising code, logic, or instructions for performing one or more steps. A user device may comprise one or more processors capable of executing one or more steps, for instance in accordance with the non-transitory computer readable media. The user device may comprise a display showing a graphical user interface (GUI). The user device may be capable of accepting inputs via a user interactive device. Examples of such user interactive devices may include a keyboard, button, mouse, touchscreen, touchpad, joystick, trackball, camera, microphone, motion sensor, heat sensor, inertial sensor, or any other type of user interactive device. For example, a user may input identity verification requests, approvals, or denials to the system via one or more user interactive devices. The user device may be capable of executing software or applications provided by one or more systems (e.g., financial institution, platform, etc.). One or more applications may be related to identity verification, fund transfer, payment processing, or financial transactions. One or more applications and/or software may be implemented in conjunction with a user interface on a GUI. For example, the user interface can be a mobile-based interface and/or a web-based interface. The user interface may be as simple as a single LED light.

A user device may comprise one or more sensors. For example, a user device may comprise one or more geo-location sensors that may be useful for detecting the location of the user device. For example, the geo-location sensors may use triangulation methods or global positioning systems (GPS) to aid in determining a location of the computing device. For example, one or more cell towers can use triangulation methods to locate a user device emitting or transmitting signals. A user device may comprise an image capture device or other optical sensor (e.g., camera) and be capable of capturing an image and/or reading an image (e.g., a code, text, etc.). For example, a camera can be integrated in the user device. The camera can be an external device to the user device and communicate via wired (e.g., cable) or wireless (e.g., Bluetooth, Wi-Fi, NFC, etc.) connection. The image capture device may be useful for capturing an image of the user or any other object within the user's environment. In some instances, the user device may receive, or access one or more images captured by an external device in the external device memory, user device memory, and/or a separate storage space, including a database of a server or a cloud storage space or from an identifier stored on a blockchain. A user device may comprise a beacon (e.g., Bluetooth beacon) that is configured to broadcast an identifier or other data to nearby electronic devices. A user device may comprise an electronic display capable of displaying a graphical user interface.

The user device may be, for example, one or more computing devices configured to perform one or more operations consistent with the disclosed embodiments. In some instances, the software and/or applications may allow users to register with the platform, register with the financial institution, register with the identity service, register with the identity broker, transmit and/or receive requests, commands, or instructions relating to identity verification and/or financial transactions, detect a location of the user device, broadcast an identifier or other data, transmit, receive, and/or process data, capture an image, read an image, such as read text via one or more optical character recognition (OCR) algorithms or read a code via one or more decrypting or decoding algorithms, and/or display an image.

The platform may communicate with one or more users or entities (e.g., ID holder, ID recipient, identity service, identity broker etc.) via the network to coordinate one or more identity verification transactions from, to, and/or between the one or more users or entities. In some instances, the platform may be configured to reliably identify an individual user (internally with the platform) and authenticate the identified individual before accepting a user command or instruction (e.g., identity verification instruction). To accomplish this, the platform may be programmed with (or otherwise store in memory instructions to implement) software and/or application to authenticate a user by requesting unique user credentials (e.g., PIN, passcode, password, username, cryptographic proof, etc.) and verifying identification. In some instances, the platform may be in communication with hardware, for example, a biometric reader, for distinguishing the identity of the authorized user from an impostor. The biometric reader may require an enrollment step, methods, and hardware for acquiring the biometric data, and methods for comparing the biometric data that is acquired with the biometric data that the user enrolled with. A biometric reader used in this capacity may have thresholds for determining whether a biometric reading falls within the acceptable confidence range of the enrolled content. In some instances a biometric reader of this type may have built-in controls that prevent the biometric reader from being tampered with, should an impostor wish to use unintended means for accessing or authorizing sharing of the content. In some instances, the platform may communicate with an external device comprising the biometric reader. For example, user devices can comprise biometric readers (e.g., sensors for fingerprints, retina, audio, facial recognition etc.) communicating with the platform.

The platform and/or user devices of the users can individually or collectively comprise a biometric module for collecting, storing, processing, translating or analyzing biometric data. Biometric data may include any feature or output of an organism that can be measured and used to uniquely identify the organism. Biometric data may include, but are not be limited to, fingerprints, DNA, body temperature, facial features, hand features, retina features, ear features, and behavioral characteristics such as typing rhythm, gait, gestures and voice. The biometric module may receive data from biometric readers, for example, a fingerprint reader or retinal scanner, optical sensors, microprocessors, and RAM/ROM memory. Software components of the biometric module may comprise one or more software-based programs, including applications, protocols, or plugins, configured for collecting and/or processing biometric data from the hardware components of the biometric module. In some instances, collection and processing biometric data may comprise operations for analyzing the biometric data, creating a template (i.e. digital template) for biometric data, storing, matching, and verifying the biometric data (i.e. with an external database or previously stored information). In some embodiments a biometric reader may also be coupled to a user device through wired or wireless approaches. Wireless approaches may include one or more types of Wi-Fi or peer-to-peer (P2P) networking protocols. In other embodiments a biometric reader may be built into the web-enabled device. In some embodiments, the biometric module may be included, installed, or attached to the user device.

The platform may comprise one or more servers to perform some or all operations of the platform, as described herein. A server, as the term is used herein, may refer generally to a multi-user computer that provides a service (e.g. validation, etc.) or resources (e.g. file space) over a network connection. The server may be provided or administered by an online service provider or administrator. In some cases, the server may be provided or administered by a third party entity in connection with a device provider. Any description of a server herein can apply to multiple servers or other infrastructures. For example, one or more servers can collectively or individually perform the operations of the platform disclosed herein. In some instances, the server may include a web server, an enterprise server, a database server, or any other type of computer server, and can be computer-programmed to accept requests (e.g., HTTP, or other protocols that can initiate data transmission) from a computing device (e.g., a user device, a public share device) and to serve the computing device with requested data. In addition, the server can be a broadcasting facility, such as free-to-air, cable, satellite, and other broadcasting facility, for distributing data. The server may also be a server in a data network (e.g., a cloud computing network, peer-to-peer configuration, etc.).

In some instances, the online service provider of the platform may administer one or more servers to provide various services to users of the system. While some disclosed embodiments may be implemented on the server, the disclosed embodiments are not so limited. For instance, in some embodiments, other devices (such as one or more user devices of the users) or systems (such as one or more financial institutions, identity services, identity brokers) may be configured to perform one or more of the processes and functionalities consistent with the disclosed embodiments, including embodiments described with respect to the server.

FIGS. 5 and 6 illustrates an example method for creating multiple avatars associated with a master avatar. Decentralized systems and methods for verifying identities, such as using avatars, are described in International Publication No. WO2019/246626, which is entirely incorporated herein by reference.

FIG. 5 illustrates an example process flow for creating a master identity profile or master avatar. A user may have a real identity (ID) (e.g., diver license, passport, etc.) that is verified by a verifying entity 501 (also referred to herein as digital certifier or digital identity certifier), such as a bank or other authoritative entity, as described elsewhere herein. The verifying entity 501 may hash the user's ID data to generate hashed ID data 503, and store the hashed ID data on each of (i) an external database 519 that is not on a blockchain which contains the master identifier 511 and (ii) a verifying entity database 521 that is also external to the blockchain. If the hashed version of the real ID data already exists in the central entity database, the user can create a new master avatar that links to the existing hashed version of the real ID data in the central entity database (e.g., the American World Money Database). If the hashed version of the real ID data does not exist, the user can create a master avatar and a new hashed version of the real id data in the central database through a certifier application. The certifier can then link the master avatar to the hashed version of the real ID data and the blockchain address. The certifier can create a digital signature for both the master avatar and the certifier to sign the hashed version of the real ID data. The master avatar signs before the certifier signs. Once the hashed version of the real ID is signed, it is stored on the central entity database. In some instances, the data is not stored on the blockchain. The digital identity (e.g., AWMeID) can also be stored and linked to the hashed version of the real ID data on the central entity database. The external database 519, while described in singular form, may comprise one or more databases. The verifying entity database 521, while described in singular form, may comprise one or more databases. The hashed ID data may comprise one or more data attributes. In some instances, a data attribute may comprise an ‘ID type’ (e.g., driver's license) and corresponding ‘ID type value’ (e.g., driver license number). The data attributes stored in the databases 519, 521 may be hashed, such as by hash-based message authentication code (HMAC) algorithm(s), such that the actual user information (e.g., actual driver license) is not stored on the databases 519, 521. The actual user information may be provided to the databases 519, 521 only in hashed format by the verifying entity. A private key of the master avatar may be managed by the verifying entity 501. Alternatively or in addition, the private key may be managed by the user (e.g., upon request).

In some embodiments, prior to storing the hashed ID data on the external database 519, the verifying entity 501 may perform a cross-reference search with data attributes of the ID data (e.g., name, permanent address, etc.) against existing data attributes in the external database 519 to confirm that the user is unique to the system. For example, the verifying entity 501 may (i) determine that the user is not unique to the system if there is overlapping data (e.g., to a certain degree, any overlapping data, etc.) already stored in the external database 519, or (ii) determine that the user is unique to the system if there is no overlapping data (e.g., to a certain degree, no overlapping data at all, etc.) already stored in the external database 519. Upon confirmation that the user is unique to the system, the hashed ID data 503 may be stored in the external database 519, and master avatar created. Upon confirmation that the user is not unique to the system, the hashed ID data 503 may not be stored in the database 519, and the user may be denied creation of a new master avatar. In such cases, the user may switch verifying entities, e.g., to the verifying entity that certified the existing master avatar for the user.

The verifying entity 501 may create a master avatar 507 (or master identity profile) of the user. The master avatar 507 may be assigned a unique master identifier (ID) 511 (or security number) which is unique to the user on a decentralized network (e.g., the blockchain). The master ID 511 may be established on the blockchain. The master ID 511 may be stored in the external database 519. The master avatar 507 and/or the master ID 511 may comprise or be associated with the hashed ID data 503 that are stored in the external database 519. A digital signature may be created. The master avatar 507 and the verifying entity 501 may each sign the hashed ID data 503 with the respective private key to generate signed, hashed ID data 505. The signed, hashed ID data 505 may be stored in the external database 519, and linked to the hashed ID data 503. The external database 519 may comprise a public key and private key. Personal information of the master avatar 507 or the user may be hashed by the verifying entity 501, encrypted with the public key of the external database 519, and stored on the verifying entity database 521.

A user may have a real identity that is verified by a verifying entity, such as a bank, or other authoritative entity, as described elsewhere herein, which is used to create a master avatar, as described with respect to FIG. 5. The master avatar may be assigned a unique master ID (or security number) which is established on the blockchain. The master avatar may comprise a set of ID data attributes that are stored (e.g., in hashed form) in a database (which may comprise one more databases), associated with the master ID, and external to the blockchain. The ID data attributes may comprise data attributes that are verified by a certificate authority, such as the verifying entity or other entities. The data attributes stored in the database may be hashed, as described elsewhere herein. A private key of the user may be managed by the verifying entity. Alternatively, or in addition, the private key may be managed by the user (e.g., upon request). The master avatar may be associated with a plurality of avatars, each representing different identity profiles of the same user, and associated with the Master ID. The plurality of avatars may each comprise, or be associated with, a different subset of predefined data attributes. For example, a first avatar may be a payment avatar, comprising or associated with the following subset of predefined data attributes: credit card, checking account, digital token, rewards, shipping address. For example, a second avatar may be a signature avatar, comprising or associated with the following subset of predefined data attributes: signature (verified by verifying entity), signature (verified by a second verifying entity), signature (verified by a third verifying entity). For example, a third avatar may be a login avatar, comprising or associated with the following subset of predefined data attributes: login. For example, a fourth avatar may be a wine avatar, comprising or associated with the following subset of predefined data attributes: OverEqualAge21, wine price range, favorite wine, hometown. Any custom avatar may be created, comprising or associated with any subset of predefined data attributes. Any number of data attributes (none, a subset, all) of any avatar may be verified by one or more verifying entities. An avatar may comprise data attributes verified by only one verifying entity, or verified by a plurality of verifying entities, or by no verifying entity.

One or more databases may comprise data units for storing, for example, trusted predefined attributes of users and trusted public keys. Specific user data can be provided to a recipient if the user agrees to share that information with the recipient. For instance, the database may store hashed or encrypted user data for the user account. User data can include personal information (e.g., full name, previous names, address, phone number, email address, social security number, etc.), employment information (e.g., employer name, employer address, work email, work phone number, years of employment, etc.), financial information (e.g., credit card number, bank name, bank account number, routing number, Paypal® account, etc.), online profile information (e.g., username, nickname, password, security question & answer, etc.), and sometimes copies of physical documents (e.g., driver's license, transcript, statement, utility bill, etc.). User data may also include custom fields generated by the user or requested by the recipient. The user may provide a subset of such user data to a recipient. The database may also store information about the user that has been verified by trusted third parties. For instance, the DMV may attest that a user is over 21 years of age, and a university may verify degrees or certifications that a user has received.

Privacy can be maintained by leveraging personal information stored by these institutions which are subject to privacy data protection regulations, such as, banks, credit unions, insurers, pharmacies, airline, car rentals, universities, merchants issuing private credit card, etc. These institutions that already collect the necessary personal user information during their normal course of business, can serve as identity certifiers and can meet Know Your Customer (KYC) and Anti-Money Laundering (AML) regulatory requirements. Identity certifiers can be compensated with a certain amount of digital tokens (e.g., $0.10 US Dollar (USD) equivalent of digital tokens) for every purchase transaction made in digital tokens by the central entity (e.g., the Central Bank of the ecosystem) until the network effect in the token economy has reached critical mass and e-identity services in the ecosystem can be monetized. There is one pair of public and private key for each of the user, merchant, identity certifier and the central entity, e.g., eight keys in total. These keys can generate various combinations of encryption and decryption to ensure data protection and separation for various use purposes. Identity certifiers only provide hashed identifying personal information to the central entity once the user's global blockchain identity avatar is created. The digital avatar showcased in FIG. 5 and FIG. 6, for example, is an anonymous single address identity avatar linked to a real-world identity of that user. The digital avatar can be stored in an identity certifier's white-labeled digital wallet application. Beneficially, the digital avatar can be portable, self-sovereign, and once created, capable of being used indefinitely and everywhere, such as for online login authentication, digital signatures, and email verification.

In some instances, a transaction may comprise a broadcast and/or airdrop of information and/or digital tokens. In some instances, a transaction may comprise a fund transfer. In some instances, a transaction may require a certain (or predetermined) number, identity, and/or weight of signature(s) to process. In some instances, such requirement may correlate to a level of identity verification desired for the transaction, where signatures associated with a certain combination of data attributes that can be used for identity verification can satisfy the requirement. In some instances, an avatar may comprise a subset of data attributes that satisfies this requirement. In some instances, an avatar may comprise a subset of data attributes that does not satisfy this requirement, in which case such avatar may not be used in conjunction with this transaction. In an example, a transaction may require a signature from certain authorities and/or avatars to process. In another example, a transaction may require a predetermined weight of signatures to process. In some instances, signatures from different sources may be assigned a weight, and there may be a predetermined weight threshold for the transaction to process. In an example, an avatar signature is assigned a weight of 2, a first certificate authority signature is assigned a weight of 1, and a second certificate authority signature is assigned a weight of 1, and the predetermined weight threshold is 3. In this example, a combination of the avatar signature and the first certificate authority signature, a combination of the avatar signature and the second certificate authority signature, and a combination of the avatar signature, the first certificate authority signature, and the second certificate authority signature, may each satisfy the predetermined weight threshold, but other combinations of the three signatures (e.g., first certificate authority signature and second certificate authority signature only) may not satisfy the predetermined weight threshold to process the transaction. Beneficially, such weighted multi-signature scheme may allow a transaction to be associated with a flexible level of identity verification level. In the above example, for instance, the transaction will not process without an avatar signature, as it is required to meet the predetermined weight threshold of 3.

FIG. 6 illustrates an example method for creating multiple avatars associated with a master avatar. A subset Avatar, such as “wine avatar” is inked under the master avatar. The Master avatar can be linked to the blockchain address and hashed version of the real ID data. The predefined attributes can be the user's attributes and preferences data that can be chosen to be shared with the central database. In some cases, the user's attributes and preferences are shared as part of a reward service through a merchant user. Each subset avatar can have predefined attributes. A user may have a real identity that is verified by a verifying entity 601, such as a bank, or other authoritative entity, as described elsewhere herein, which is used to create a master avatar 603. The master avatar 603 may be assigned a unique master ID (or security number) which is established on the blockchain. The master avatar 603 may comprise a set of ID data attributes that are stored (e.g., in hashed form) in a database (which may comprise one more databases), associated with the master ID, and external to the blockchain. The ID data attributes may comprise data attributes that are verified by a certificate authority, such as the verifying entity 601 or other entities. The data attributes stored in the database may be hashed, as described elsewhere herein. A private key of the user may be managed by the verifying entity 601. Alternatively or in addition, the private key may be managed by the user (e.g., upon request). The master avatar 603 may be associated with a plurality of avatars (e.g., 604, 605, 606, 607), each representing different identity profiles of the same user, and associated with the Master ID. The plurality of avatars may each comprise, or be associated with, a different subset of predefined data attributes. For example, a first avatar 604 may be a payment avatar, comprising or associated with the following subset 640 of predefined data attributes: credit card, checking account, digital token, rewards, shipping address. For example, a second avatar 605 may be a signature avatar, comprising or associated with the following subset 650 of predefined data attributes: signature (verified by verifying entity 601), signature (verified by a second verifying entity), signature (verified by a third verifying entity). For example, a third avatar 606 may be a login avatar, comprising or associated with the following subset 660 of predefined data attributes: login. For example, a fourth avatar 607 may be a wine avatar, comprising or associated with the following subset 670 of predefined data attributes: OverEqualAge21, wine price range, favorite wine, hometown. Any custom avatar may be created, comprising or associated with any subset of predefined data attributes. Any number of data attributes (none, a subset, all) of any avatar may be verified by one or more verifying entities. An avatar may comprise data attributes verified by only one verifying entity, or verified by a plurality of verifying entities, or by no verifying entity.

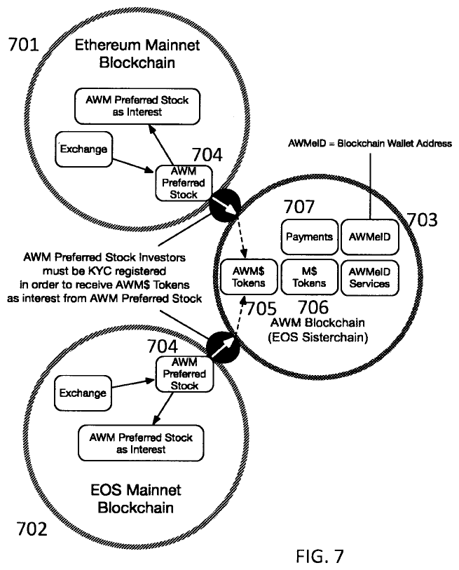

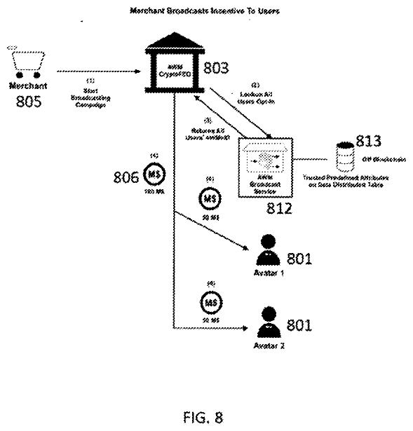

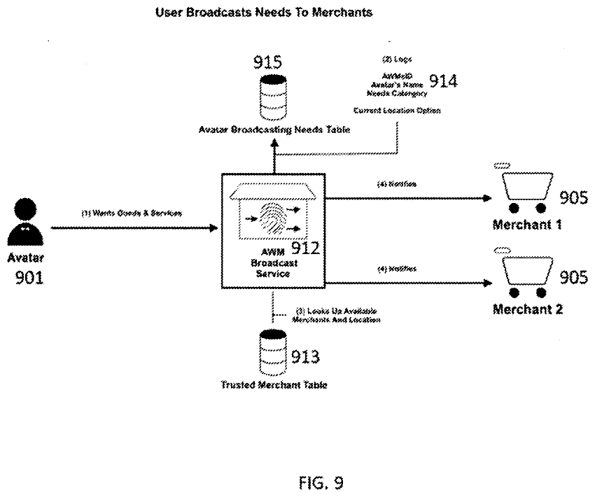

FIG. 7 shows the interaction of the a private blockchain 703 with multiple blockchains, 701 and 702, in the three-token model, wherein cryptocurrency may be used to purchase preferred stock 704 which may be exchanged for digital tokens 705, reward tokens 706. The blockchain 701 and 702 can be public blockchains. The preferred stock 704 can be publicly traded at cryptocurrency exchanges 701,702 (e.g., Ethereum or EOS or another blockchain platform). The preferred stock holders can be KYC registered. The interest paid to the preferred stock 704 can be in-kind or in digital token 705 for which preferred stock holders can be KYC registered in advance. The private blockchain 703 will be on EOS sisterchain or other private blockchain, in which the digital tokens 705 and reward tokens 706 corresponding tokens at FIG. 2 and FIG. 4 reside. Payments 707 referrers to payments at FIG. 2. “AWMeID” refers to digital identity services related to the Avatar, such as FIG. 6, FIG. 8 and FIG. 9 which reside in private blockchain 703. Payments 707 are not fiat currency. Notice that “Preferred Stock”, “Bond”, “Governance Token” are used interchangeably and refer to “Non Stable Token” in this specification.

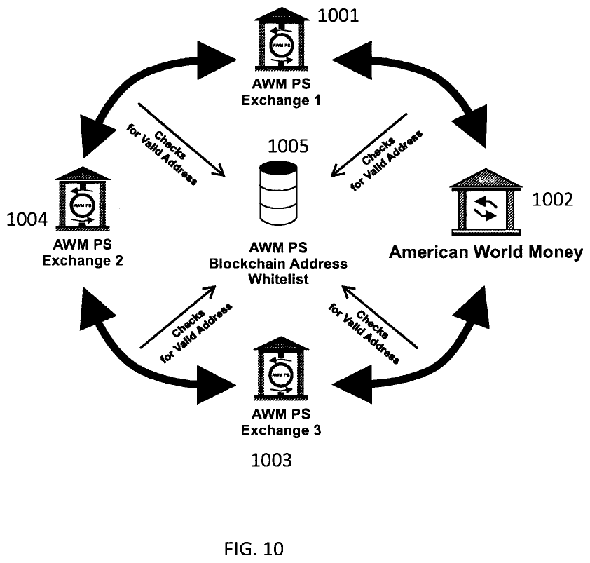

FIG. 10 illustrates an overview of a preferred stock cryptocurrency exchange network in which each individual exchange 1001, 1003, 1004 are locked in a closed-loop market with the central entity account 1002. In such a set up, each individual exchange can access the blockchain preferred stock blockchain address to check and validate the address between each exchange and between each exchange and the central entity account.

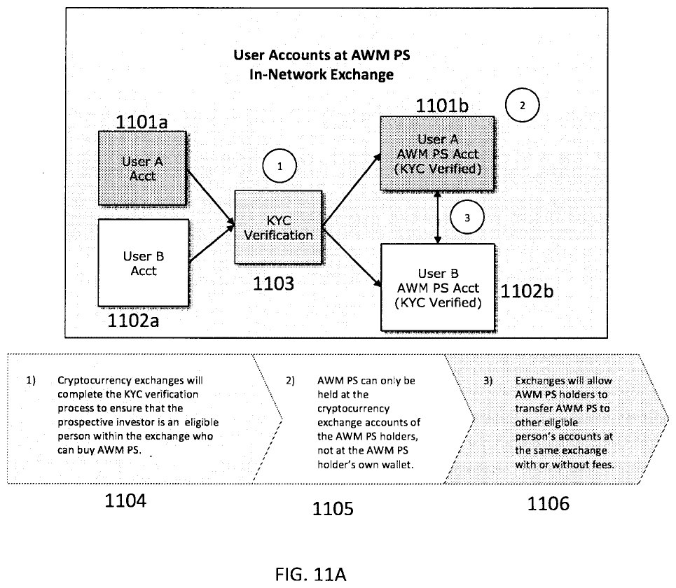

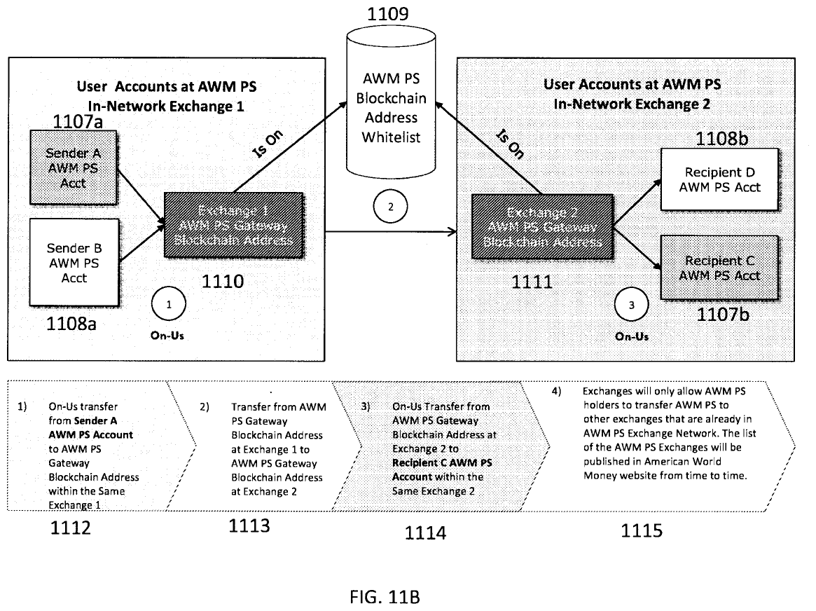

FIG. 11A illustrates an individual preferred stock transfer within a preferred stock exchange. In step 1104, cryptocurrency exchanges complete the verification process (e.g., KYC verification process) to ensure that the prospective investor (e.g., user A 1101a or user B 1102a) is an eligible user within the exchange who can purchase preferred stock. In step 1105, the preferred stock can only be held at the cryptocurrency exchange accounts of the preferred stock holders (e.g., verified user A 1101b and verified user B 1102b) instead of their own digital wallets. In step 1106, the exchanges allow the preferred stock holders (e.g., verified user A 1101b and verified user B 1102b) to transfer preferred stock to another user's account with or without fees.

FIG. 11B illustrates transfers of preferred stock between in-network exchanges. In step 112, Sender A initiates an “on us” transfers from an account belonging to Sender A 1107a to a first preferred stock gateway blockchain address within the same exchange 1110. In step 1113, the transfer from the preferred stock gateway blockchain address within the same exchange 1110 transfers the data of the exchange to a second preferred stock blockchain address at a second exchange 1111. In step 1114, the “on us” transfer data is transferred from the second preferred stock gateway blockchain address at the second exchange 1111 to a preferred stock account belonging to Recipient C 1107b within the second exchange. In step 1115, the exchanges only allow preferred stock holders to transfer preferred stock to other exchanges that are already in the preferred stock network. The list of the exchanges can be made publicly available by the central entity (e.g., AWM). Other tokens, such as stable tokens can also be traded in the in-network exchanges. The central entity (e.g., CryptoFed) may build an exchange (e.g., a CryptoFed Exchange) for internal use. In an example, the Crypto Exchange only has two trading pairs among a stable token (e.g., “Ducat”), a non-stable token (e.g., “Locke”), and fiat currency, (e.g., USD). The CryptoFed Exchange may interact with other in-network exchanges.
i. Ducat/USD
   The purpose is to maintain Ducat inflation protected Target Exchange Rate against USD by market force.
ii. Ducat/Locke
   The purpose is to adjust Ducat supply using Locke′ buying and selling to achieve the Ducat's Target Exchange Rate against USD.

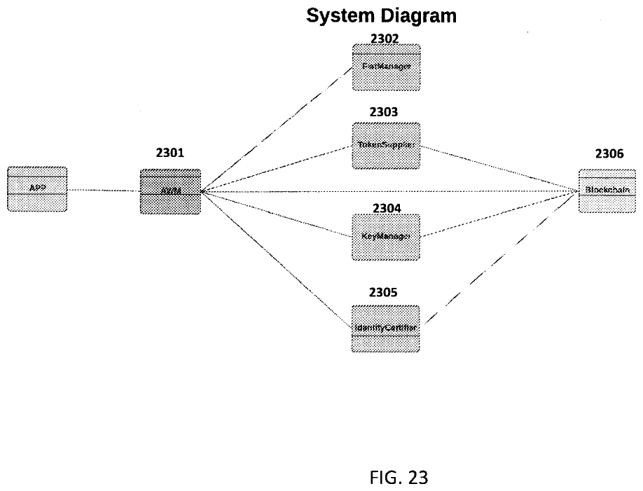

FIG. 23 shows a diagram of an exemplary structure of the system the interaction of each subsystem with one another. The system comprises the following subsystems: a central entity database 2301, a fiat manager 2302, a token supplier 2303, a key manager 2304, an identity certifier 2305, and a blockchain 2306. The central entity database 2301 can be a main system that coordinates all of the other subsystems. The fiat manager 2302 can manage the buying and selling of tokens using fiat currency. The token supplier 2303 can help distribute blockchain tokens to users. The key manager 2304 can manage user keys required to conduct transactions. The identity certifier 2305 can verify the user identity to establish a digital identity (i.e., AWMeID). The blockchain 2306 can be used as the basis of the token network.

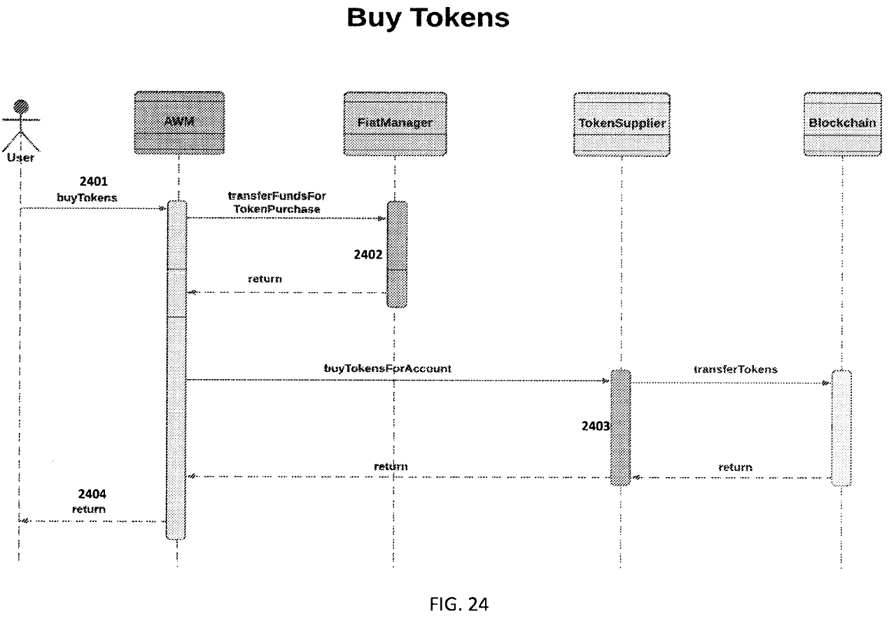

FIG. 24 shows a diagram illustrating a sequence for token exchanges. The fund manager can manage the funding for the token exchange. The token supplier can manage the token supply for the blockchain. The fiat source can be any funding source for the user (e.g., USD, EUR, etc.). In 2401, the user request to purchase a certain number of tokens. In 2402, the central entity (AWM) sends a request to the fiat manager to transfer fiat into a holding account. In 2403, the funding is confirmed and the central entity instructs the token supplier to transfer the purchased tokens to the user's account. In 2404, the user is informed of the completed status of the token purchase. Point of Sales can be online store checkout. A similar implementation can be embedded in merchants' online store working independently or integrating to merchants' fiat payment system.

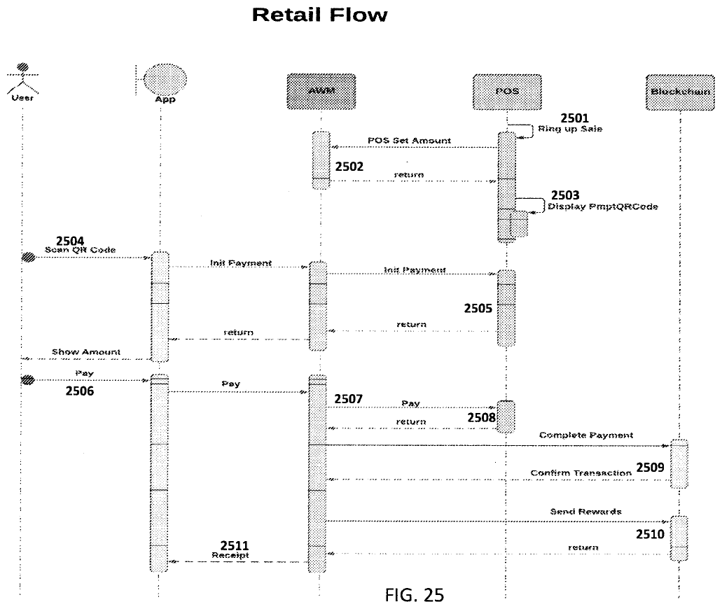

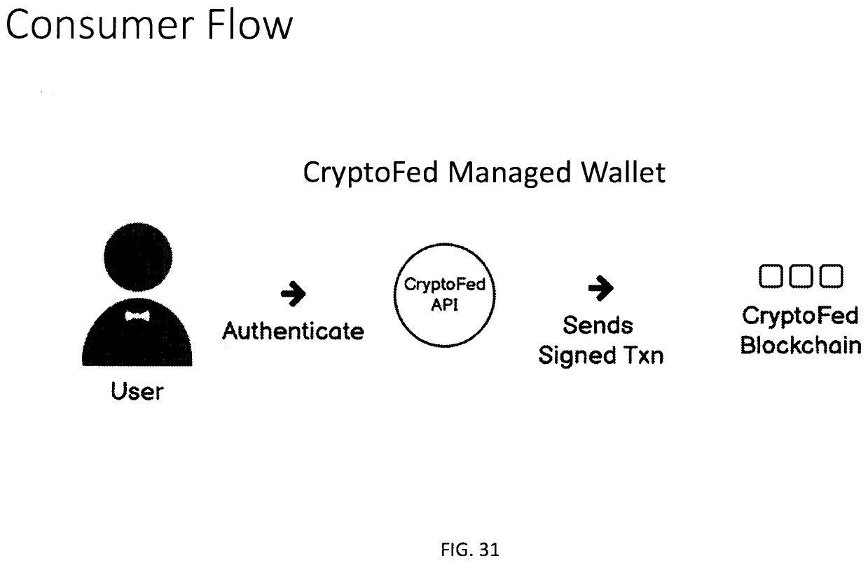

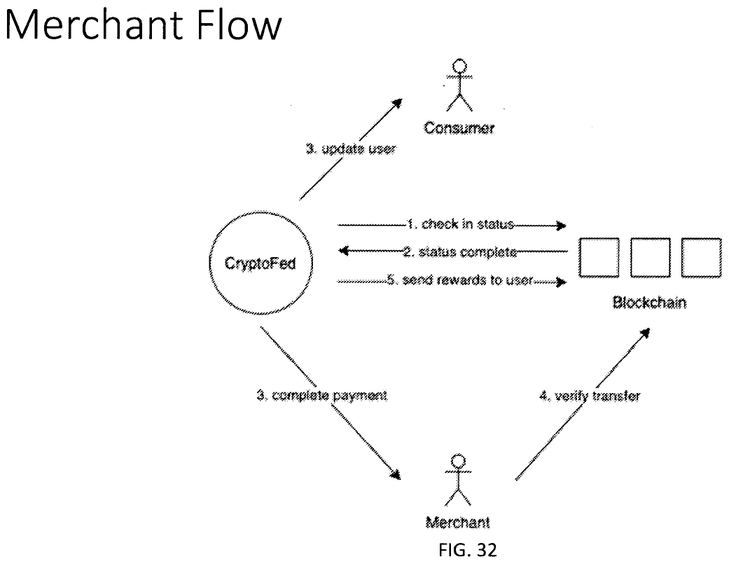

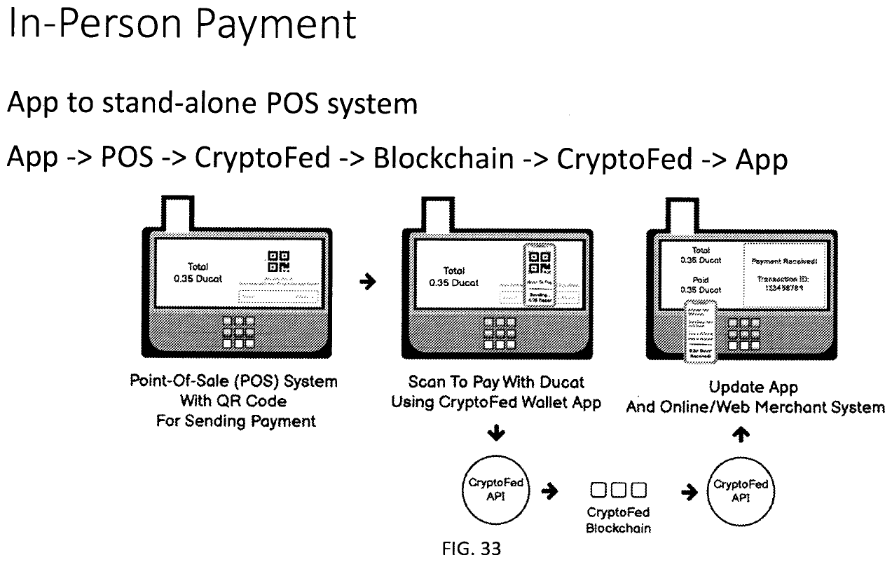

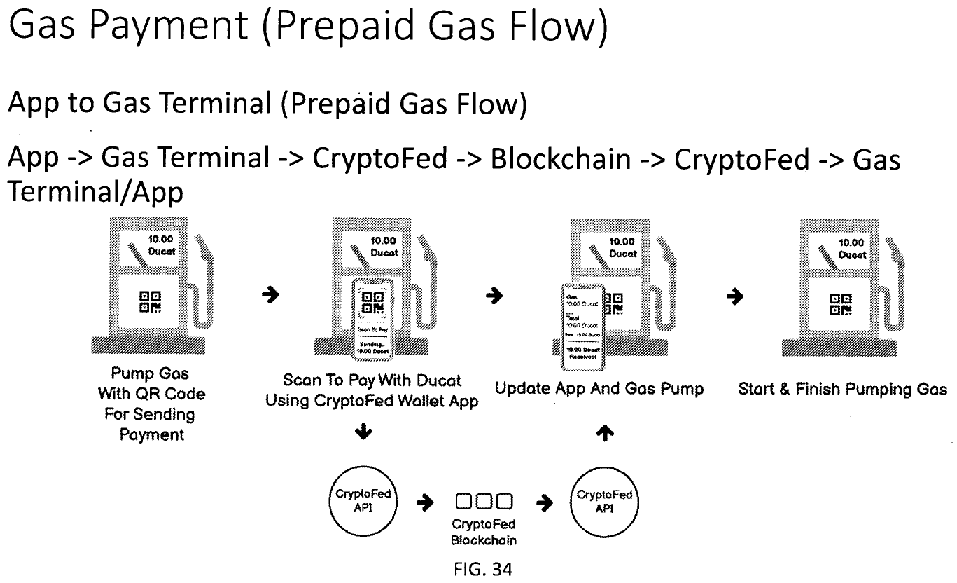

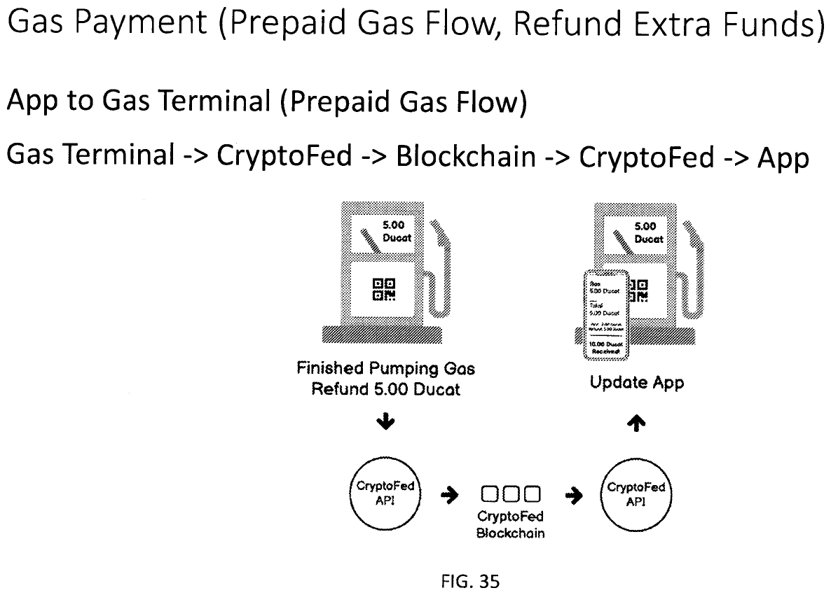

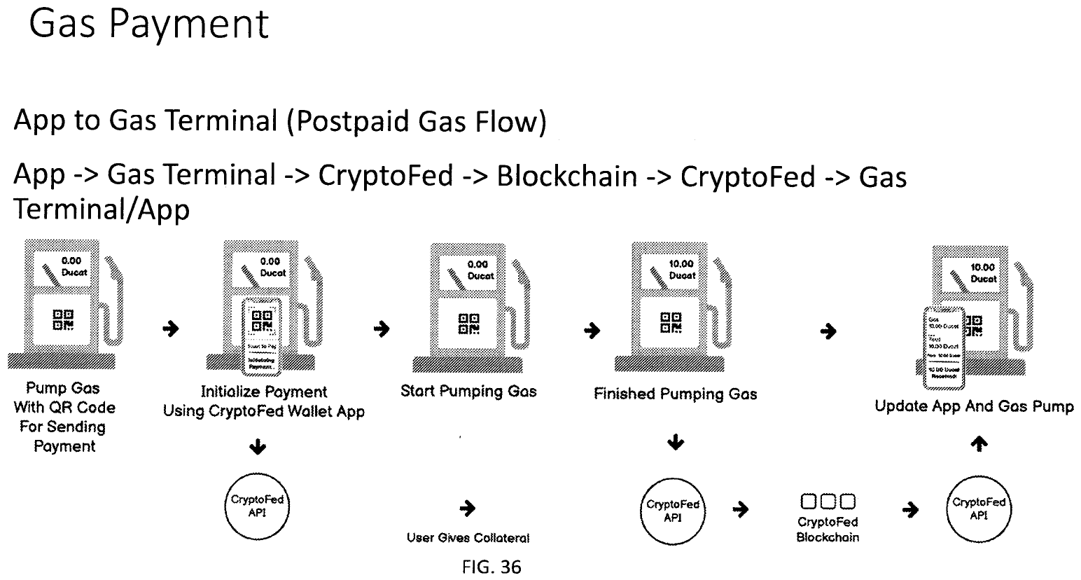

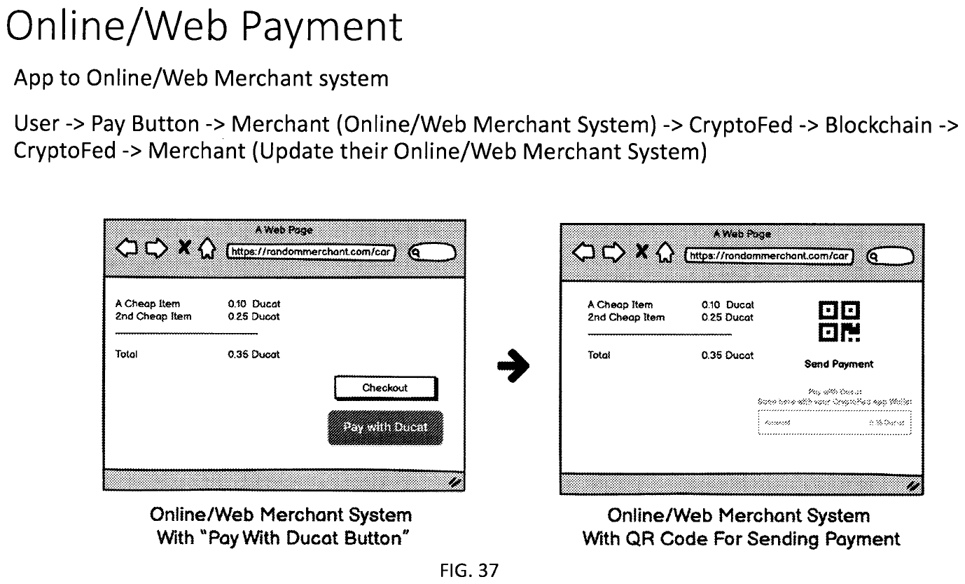

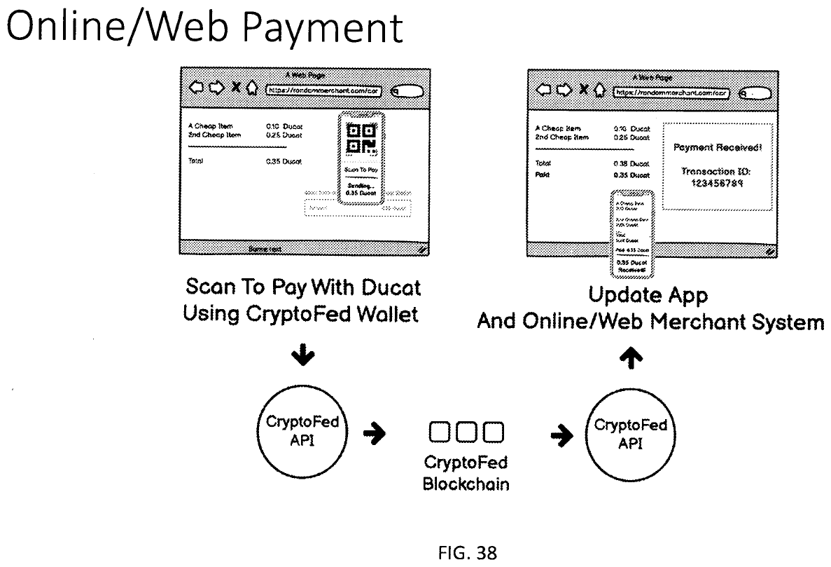

FIG. 25 shows a diagram illustrating a sequence for retail payment. The retail payment can be for goods or services. The application can be the primary interface used to interact with the system to perform the transaction. The central entity's transaction management system (i.e., AWM system) can communicate with the end user via the application and the merchant through the point of sale. The central entity can comprise a module that communicates with the point of sale directly to relay data to the central entity. The point of sale can allow the merchant to register sales, enter sales amounts, and approve transactions. The blockchain can record all approved transactions related to any blockchain token exchanges. In 2501, the merchant registers a sale on the point of sale system. In 2502, the point of sale initiates a new transaction request with the central entity. In 2503, the central entity sets the amount for the payment point and returns the payment point code that the terminal should display. In 2504, the user scans the payment point to initialize the payment. In 2505, the central entity notifies the point of sale that the user has initiated payment. In 2506, the user approves the transaction. In 2507, the central entity receives the pay request and sends out a pay request to the point of sale to confirm that payment is being made by the user. In 2508, the point of sale completes the payment on the merchant side and lets the central entity know whether the processing is complete. In 2509, the central entity completes the transaction with the blockchain and transfers the tokens from the user account to the merchant account. In 2510, the central entity can send reward tokens to the user's account. In 2511, a receipt is sent back to the user. FIG. 31 shows a diagram illustrating a sequence for consumer flow. As shown in FIG. 31, a user may log in an issuing entity's API through an authentication process. Then a signed transaction may be sent to the issuing entity's blockchain. This consumer flow may be facilitated by the issuing entity's managed wallet. FIG. 32 shows a diagram illustrating a sequence for merchant flow. As shown in FIG. 32, the issuing entity (CryptoFed) may issue a check-in status command to the blockchain. The blockchain may respond by sending a status complete acknowledgement to the issuing entity. Next, the issuing entity may send update user to one or more consumers, and send a complete payment notification to a merchant. The merchant may then verify the transfer with the blockchain. Next, the issuing entity may send rewards to users via the blockchain. FIG. 33 shows a diagram illustrating a sequence for in-person payment. As shown in FIG. 33, the systems and methods provided herein may comprise an App (application) to stand-alone Point-Of-Sale (POS) system. The App may initiate a transfer or transaction by working with a POS system. The POS system may generate Quick Response (QR) code for sending payment. A user's device may be utilized to scan the QR code to make the payment with stable tokens in a wallet application. This may invoke the issuing entity's API and send the transfer of payment via blockchain. Once the transfer of payment is completed, the systems and methods provided herein may update the App and a merchant system (e.g., update online/web merchant system). FIG. 34 shows a diagram illustrating a sequence for an exemplary gas payment. As shown in FIG. 34, the systems and methods provided herein may comprise an App (application) to gas terminal (prepaid gas flow). The App may initiate a transfer or transaction by working with the gas terminal. The gas terminal may generate a Quick Response (QR) code for sending payment. A user's device may be utilized to scan the QR code to make the payment with stable tokens in a wallet application. This may invoke the issuing entity's API and send the transfer of payment via blockchain. Once the transfer of payment is completed, the systems and methods provided herein may update the App and a gas terminal (e.g., gas pump). Next, the gas pump may start to pump gas, and when the scheduled amount of gas is pumped, finish pumping gas. FIG. 35 shows a diagram illustrating a sequence for an exemplary gas payment. As shown in FIG. 35, the systems and methods provided herein may comprise an App (application) to gas terminal (prepaid gas flow, refund extra fund). The App may initiate a transfer or transaction by working with the gas terminal. The gas terminal may generate a QR code for sending payment. A user's device may be utilized to scan the QR code to make the payment with stable tokens in a wallet application. This may invoke the issuing entity's API and send the transfer of payment via blockchain. Once the transfer of payment is completed, the systems and methods provided herein may update the App and a gas terminal (e.g., gas pump). Next, the gas pump may start to pump gas, and when a tank is full, and there is still remaining stable token (e.g., 5 Ducat as shown in FIG. 35), the gas pump may finish pumping gas and refund the extra fund by updating App and/or a digital wallet. FIG. 36 shows a diagram illustrating a sequence for an exemplary gas payment. As shown in FIG. 36, the systems and methods provided herein may comprise an App (application) to gas terminal (postpaid gas flow). The App may initiate a transfer or transaction by working with the gas terminal. The gas terminal may generate a QR code for initializing payment using the issuing entity's wallet App. This may be facilitated by the issuing entity's API and a user gives collateral through the API. At this time, the gas terminal may allow a user to pump gas. When the user finished pumping gas, the resultant amount of payment due is send to the issuing entity's API, and through blockchain, the system may update the App and the gas pump. FIG. 37 shows a diagram illustrating a sequence for an exemplary online/web payment. As shown in FIG. 37, an App to online/web merchant system is provided. A user may click a pay button in that App, which will initiate a transfer of stable token. a merchant's web page may generate a QR code for sending the payment. The payment may be transferred via blockchain, and may be completed by updating the online/web merchant system. FIG. 38 shows a diagram illustrating a sequence for an exemplary online/web payment. As shown in FIG. 38, an App to online/web merchant system is provided. A user may scan (using a user device) a QR code on a merchant's web page to pay with stable tokens. The issuing entity's API will transfer the payment in stable tokens via blockchain to the merchant system. The transfer of payment may be completed by updating the online/web merchant system.

FIG. 8 shows a schematic illustration of the issuance of digital token rewards 806 to user accounts 801. The merchant 805 may transmit a request to a central entity 803 to broadcast content (e.g., issue digital token rewards 806) with a set of broadcast conditions, such as via airdrop. For example, the broadcast conditions may comprise user accounts 801 that have one or more predefined attributes. The predefined attributes may be received from the users and stored in a central database table 813 (e.g., American World Database). The central entity 803 may use the Broadcast Service 812 of the central entity 803 to identify (e.g., “lookup”) and return the user accounts 801 meeting the predefined attributes, and nearly simultaneously broadcast the content (e.g., issue the digital reward tokens 806) to the user accounts 801, wherein the digital reward tokens 806 are backed up by digital tokens in the merchant account.

FIG. 9 shows a schematic illustration of a service to facilitate the transfer of information from a user account. A user associated with an avatar 901 may provide a broadcast request 914, such as including their location and broadcast criteria, to a Broadcast Service 912 of the central entity, which may store such broadcast request and/or contents thereof (e.g., one or more predefined attributes) in an avatar broadcasting needs data unit 915. The broadcast criteria may correspond to one or more predefined attributes (e.g., user location, user wants Thai food, etc.). The Broadcast Service 912 may identify (e.g., “lookup”) a trusted merchant data unit 913 to identify and return a list of participating merchants 905 which meet the broadcast criteria. The central entity may then provide the user's broadcast request 914 in the broadcasting needs data unit 915, and/or contents thereof, to the list of participating merchants 905. The trusted merchant data unit 913 and the broadcasting needs data unit 915 can be on the central entity database (e.g., American World Database).

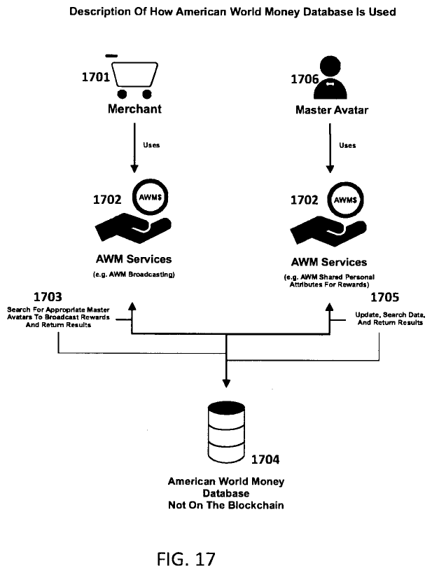

FIG. 17 illustrates a description of how the central entity database 1704 can be used by a merchant 1701 and a master avatar 1706 of a user. Both a merchant 1701 and a master avatar of a user 1706 can use the central entity services 1702. In 1703, a merchant 1701 can use the central entity services 1702 to search for appropriate master avatars to broadcast rewards and return results. In 1705, a master avatar 1706 can use the central entity services to update their avatar and search for merchants.

Advantageously, the stable digital currency ecosystem described herein provides merchants and users with a digital currency that is designed to facilitate free commerce. The blockchain systems of the present disclosure can leverage and convert the peer to peer native broadcast capacity of cryptocurrency payments into a two-way, zero cost, direct advertising and communication platform between different users of any relationship (e.g., merchants and consumers), with unique but anonymous real-world identity of individuals on the blockchain. FIG. 8 and FIG. 9 illustrate that merchants are able to create their incentive token of loyalty/coupons/rewards (digital reward token) with their own brand and broadcast to users, while users can also broadcast their needs to merchants. Merchants and users can search broadcasts available in blockchain systems. The Broadcast Service can be provided to all participants, at no cost (e.g., digital token or fiat) or at cost.

FIG. 13 illustrates an example process flow for how a user without a digital driver license (DDL) can create a master avatar. In 1301, if a user does not have a digital driver's license, the user can download and launch a digital certifier application (e.g., AWMeID certifier application) to create a DDL. For example, a user can be directed to a registration page using the digital certifier application and fill out a registration questionnaire. The questionnaire can then be sent to a digital driver license activation website. In 1306, to create the digital driver license, a user can create login credentials in a registration app and receive a one-time activation code via short messaging, email, or regular postal mail to verify their digital driver license. In 1307, the digital driver license activation website can send a verification confirmation to the certifier app. In 1302, once the digital driver license is verified and created, the digital certifier can have access to the consumer digital driver license verified data. In 1303 and 1304, the digital certifier stores and uses the verified data to create a digital avatar (e.g., AWMeID) and Master Avatar through the consumer digital certifier app. In 1308, the user certifier app can store the verified data on a certifier database that is not on the blockchain. In 1305, once the Master Avatar has been created, the digital certifier can load tokens to the account to pay for the digital driver license registration fees through the digital token exchange app (e.g., AWMeID App.).

FIG. 14 illustrates an example process flow for avatar creation using an existing digital driver license (DDL) by an authorized digital certifier. In 1401, a user with a digital driver license downloads and launches a consumer digital Certifier App to create a Master Avatar. In 1402, the user can scan and verify their driver's license using a camera of a user device or through a consumer digital driver license API (e.g. through a collaboration with a government organization). In 1403 and 1404, the user verifies their identify by scanning a QR code or any other barcode (e.g., graphical barcode) from the digital driver license. Once the digital driver license is verified and created, the digital Identify Certifier App can have access to consumer digital driver license verified data. In 1405 and 1406, if the consumer digital driver license is valid and verified, the digital certifier can store and use the verified data to create a digital and a Master Avatar through the digital Identify Certifier App. In 1407, the verified data is stored on the certifier database. The verified data is not stored on the blockchain.

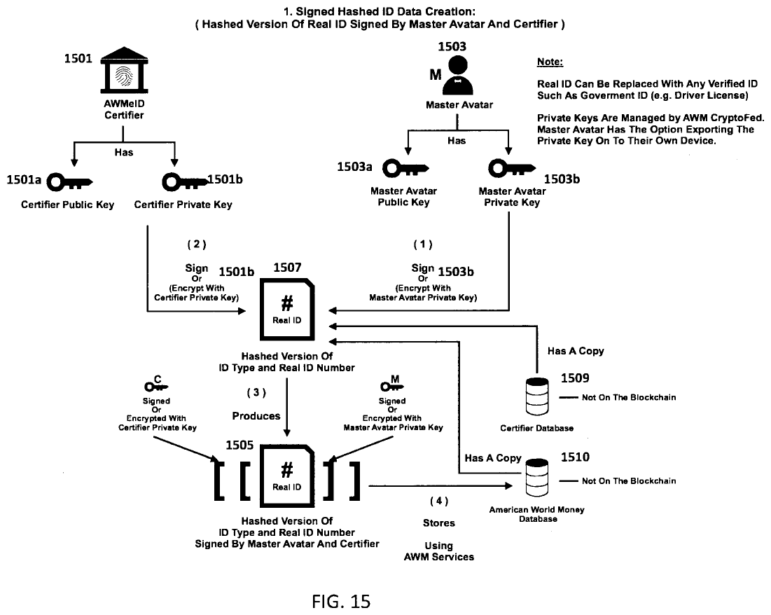

FIG. 15 illustrates an example process flow for verifying a non-specific identifier that has been assigned to an avatar. The non-specific identifier can be hashed identification data. A verifying entity 1501 may comprise a certifier public key 1501a and certifier private key 1501b. A master avatar 1503 associated with a user may comprise a master avatar public key 2103a and master avatar private key 1503b. Signed, hashed ID data 1507 may have been signed by each of the certifier private key 1501b and the master avatar private key 1503b. In some instances, the master avatar private key 1503b signs before the certifier private key 1501b signs to ensure that the verifying entity 1501 approves the hashed version of the Real ID or digital driver license data (DDL) that was signed by the master avatar 1503. Once both parties have singed the hashed version of the Real ID or digital driver license data, it will be store on the central entity's database (e.g., AWM database) and not on the blockchain. The certifier database 1509 has the only copy of the unsigned hashed version of the Real ID or digital driver license data. The signed, hashed ID data 1507 may be decrypted with the certifier public key 1501a and the master avatar private key 1503a, respectively, to generate the hashed ID data 1505. The certifier database 1509 is separate and distinct from the digital token exchange database 1510 (i.e., AWM database).

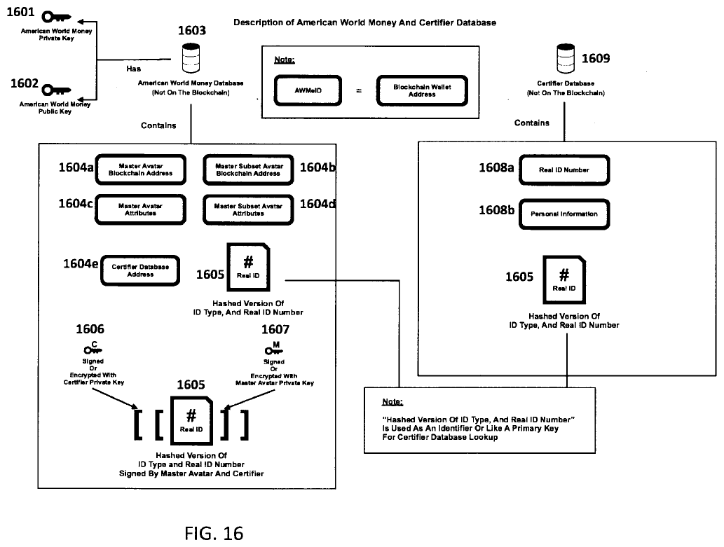

FIG. 16 illustrates a description of the encryption provided by the central entity and certifier databases to protect the user's identity and token exchange history. In order to access the database of the central entity 1603, a private key 1601 and a public key 1602 must be provided. The database of the central entity 1603 contains attributes 1604c of a user's avatar such as blockchain address 1604a, subset attributes 1604d, and subset blockchain address 1604b. The master avatar's blockchain address 1604a and the avatar's subset blockchain address 1604b can be used to send and receive digital tokens and merchant reward tokens publicly. For private transactions, a blockchain wallet address can be used to generate a one time public wallet address. Master and subset avatar attributes can be stored at the user's discretion in the central entity database 1603. The Master and subset avatar attributes can be linked to the master and subset blockchain addresses. The master and subset blockchain addresses can be linked to the hashed versions of the Real ID or digital driver license data. The signed hashed version of the Real ID or DDL data can be used to verify a user's identity only with both the verifier and the central entity decrypting the signed hashed data real ID or digital driver license data and matching the unsigned hashed real ID or digital driver license data from the central entity database. The database of the central entity 1603 can also contain the certifier database address 1604e, and a real ID identifier number 1605 to look up a real ID in the certifier database. Furthermore, the real ID identifier number 1605 can only be accessed on the central entity database 1603 with an encrypted certifier private key 1606 and an encrypted master avatar private key 1607. Separately, the certifier database 1609 contains the real ID number 1608a of the user and personal information 1608b of the user, obtainable only by searching for the real ID identifier number 1605.

The certifier database 1609, while described in singular form may comprise one or more databases. The central entity database 1603 may comprise a private key 1601 and a public key 1602. The central entity database 1603 may comprise data, such as: master avatar ID (or master avatar blockchain address 1604a), master avatar attributes 1604a, subset avatar ID 1604c (or master subset avatar blockchain address 1604b), subset avatar attributes, the certifier database address 1604e, hashed ID data 1605, and signed, hashed data 1607 which has been signed by a verifying entity. The verifying entity database 1609 may comprise real ID data (e.g., personal information 1608b, real ID number 1608a, etc.), verifying entity custom information, and hashed ID data 1605 which has been encrypted by the certifier private key 1606 and the master avatar private key 1607. The encrypted, hashed ID data 1605 may be used as an identifier, such as a primary key, to search the certifier database 1609 and/or for cross-reference purposes (e.g., to identify if a user already has a master avatar ID), as described elsewhere herein.

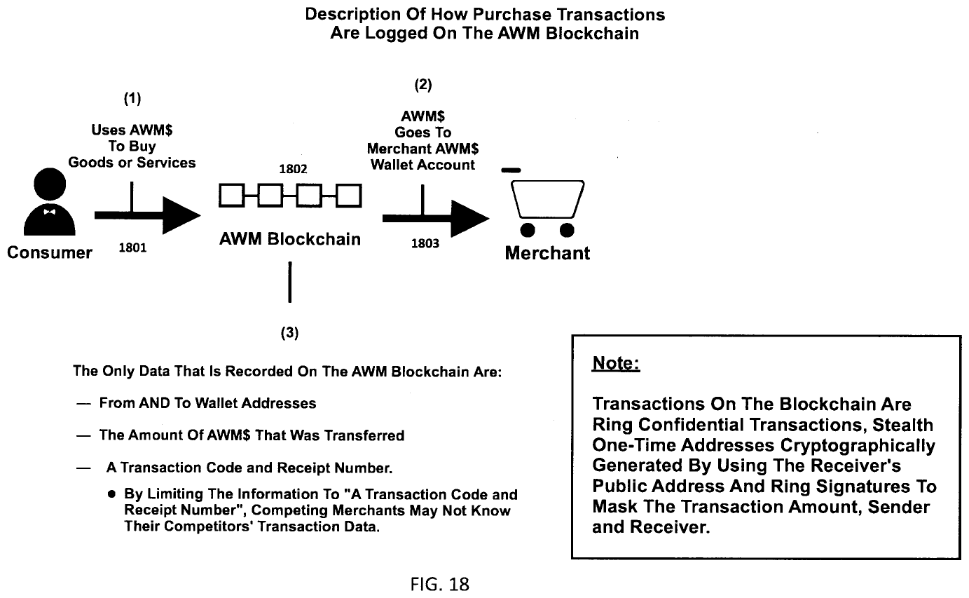

FIG. 18 illustrates a description of how purchase transactions are logged on the central entity's blockchain. In 1801, a user exchanges tokens for goods or services. In 1802, a limited amount of data is recorded on the blockchain. The data recorded on the blockchain can include the from and to wallet addresses, the number of tokens transferred, a transaction code or receipt number. In 1803, the token is transferred to a merchant token wallet account. By limiting the information to a transaction code and receipt number, competing merchants are unable to obtain their competitor's transaction data. Transactions can be ring confidential transactions, steal one-time addresses cryptographically generated by using the receiver's public address and ring signatures to mask the transaction amount, sender identity and receiver identity.

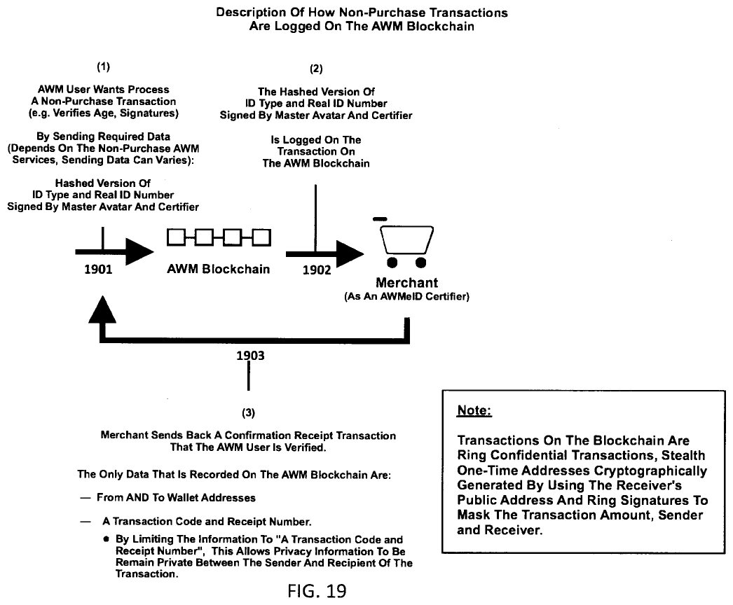

FIG. 19 illustrates a description of how non-purchase transactions are logged on the central entity's blockchain. In 1901, when a user starts a non-purchase transaction, a real ID identifier number is assigned to the transaction and signed by both the master avatar and the certifier. In 1902, the transaction is logged on the central entity's blockchain using the signed real ID identifier number. In 1903, the merchant sends back a confirmation receipt of transaction that the user is verified. The limited data recorded on the blockchain can include the from and to wallet addresses, a transaction code, and a receipt number. By limiting the information to a transaction code and a receipt number, the transaction can be kept private between the sender and recipient of the transaction. Transactions can be ring confidential transactions, steal one-time addresses cryptographically generated by using the receiver's public address and ring signatures to mask the transaction amount, sender identity and receiver identity. For example, a user can choose to verify their age to a merchant. To verify their age, real identification information, the user can send the hashed version of the real ID data (signed by the master avatar and the certifier) to the merchant. In a public transaction, the hashed version of the real ID data (signed by the master avatar and the certifier) can be logged on the blockchain transaction.

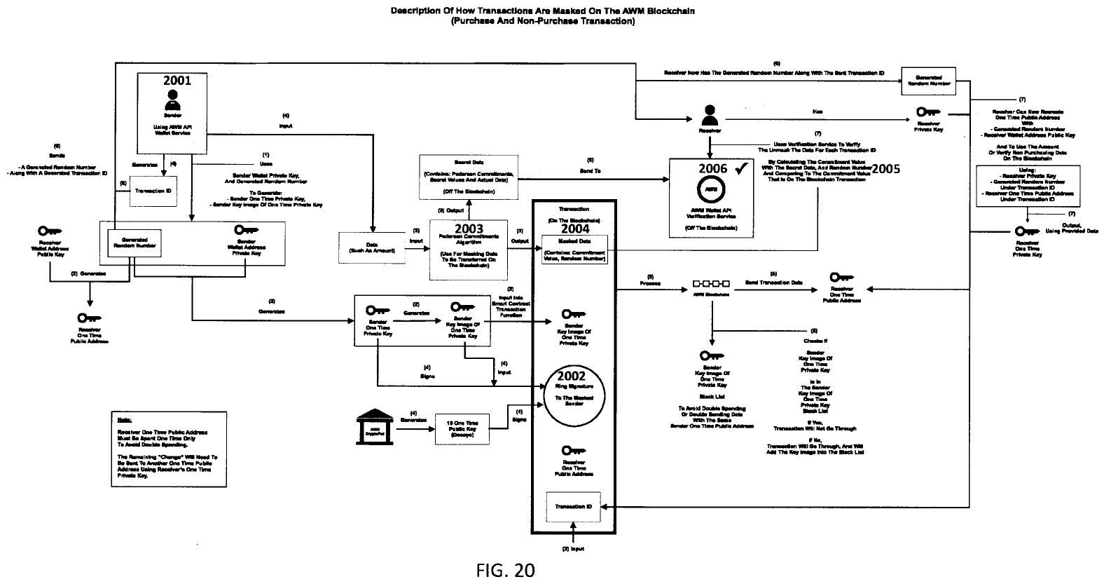

FIG. 20 illustrates how transactions are masked, according to methods described herein. The masking can involve a layer of service for digital wallet API verification where all the unmasked data along with data to recreate the hashes (for comparison/verification with the blockchain transaction data) goes through the verification service channel. On the blockchain, the sender 2001 is masked with decoy transactions through the use of ring signatures 2002. The amount or data are masked with an algorithm, such as the Pedersen Commitments Algorithm 2003. In 2005, the masked amount or data 2004 are later to be compared with the calculated masked amount or data from the actual amount and/or data that was received from the AWM Wallet API Verification Service 2006. Therefore, by comparing the masked data from the transaction on the blockchain and the calculated masked data from the actual data of the AWM Wallet API Verification Service, the transaction can be confirmed and verified.

In an example, the sender 2001 has a transaction with a receiver 2007 using a digital wallet. A transaction ID for the transaction is generated from the sender 2001 wallet. A random number or code 2008 for the transaction is generated. This random number or code 2008 is used (i) along with the private key of the sender's digital wallet address to generate a sender one time private key, and (ii) along with the public key of the receiver's digital wallet address to generate a receiver one time public address. The sender one time private key is used to generate a sender key image of the sender one time private key. Transaction data (e.g., amount) from the sender 2001 wallet is masked with one or more algorithms (e.g., Pedersen Commitments Algorithm 2003) to generate masked data 2004. A smart contract transaction on the blockchain comprises the transaction ID, the masked data 2004, the sender key image of the sender one time private key, the receiver one time public address, and a ring signature 2002. The ring signature 2002 is generated by signing with the sender one time private key along with signing by a number of decoy one time public keys. Any number of decoy keys may be used in the ring signature. The decoy key(s) may be generated by a central entity. Secret data 2010 of the masked data 2004, such as secret values and Pedersen Commitments generated during the data masking operation, may be sent to the digital wallet API verification service layer 2006 off the blockchain. The verification service layer may be used to verify and unmask the data for each transaction ID (e.g., in 2005), such as by calculating the commitment value with the secret data, and the random number, and comparing the calculated values to the commitment values on the blockchain transactions. On the blockchain, the transaction may be processed for approval or denial. The sender key image of the sender one time private key may be blacklisted in a blacklist data unit once approved to prevent double spending (e.g., double spending with the same sender one time public address). When the transaction is processed, the system may check if the sender key image of the sender one time private key is already in the blacklist data unit. If it is, to prevent double spending, the transaction may be denied. If it is not, the transaction may be approved, and the sender key image of the sender one time private key may be stored in the blacklist data unit. Once approved, the transaction data may be sent to the receiver one time public address. In parallel or subsequent to the above operations, the sender 2001 wallet may send the generated random number 2008 and the transaction ID to the receiver 2007 wallet, which has the receiver private key. The receiver 2007 may be able to recreate the receiver one time public address with the generated random number and the receiver wallet public key. The receiver 2007 may verify the transaction data (e.g., amount, non-purchasing data, etc.) on the blockchain by generating a receiver one time private key using the receiver private key, the generated random number, the receiver one time public address.

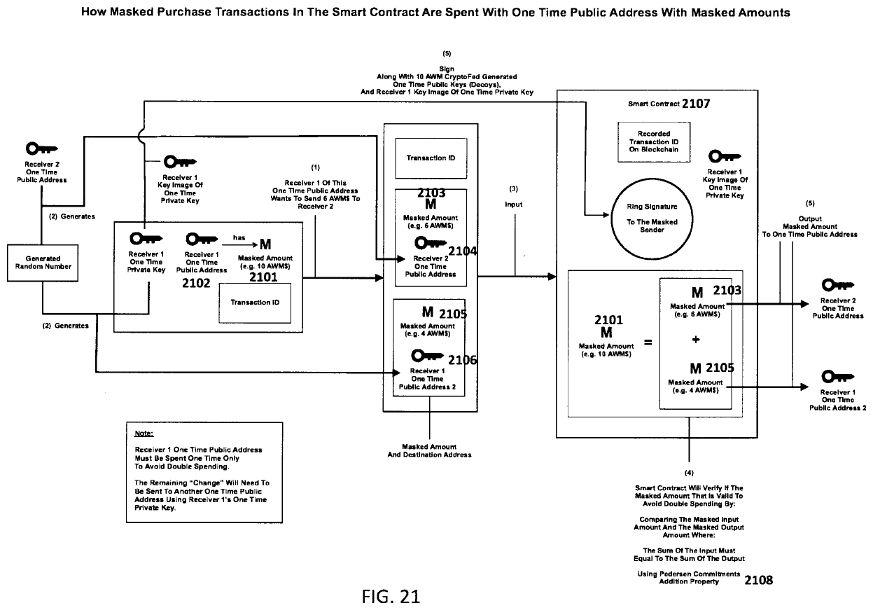

FIG. 21 illustrates how masked purchase transactions are spent using a one time public address with a masked amount. For example, if the user receives a masked amount of 10 units 2101 in a one time public address 2102, the user needs to spend the entire amount. The masked amount can be “unmasked” by using the digital wallet API verification service off the blockchain. The one time public address 2102 can only be spent once. Therefore, if the user (Receiver 1) wants to send the masked amount for 6 units 2103 (of the 10 units received) to Receiver 2 2104, the user will need to set up another one time public address wallet 2106 with the remaining amount of 4 units 2105 for the user to use in the future. The smart contract 2107 does not need to know the amount to verify the amount. The smart contract 2107 may verify that the sum of the masked input amount into the smart contract transaction 2101 is equal to the sum of 2103, 2105 of the masked output amounts of the smart contract transaction, e.g., according to Pedersen Commitment Addition principles 2108.

In an example, under a transaction ID, Receiver 1 has a receiver one time public address 2102 which has received a masked amount 2101 of 10 units. To send 6 units to Receiver 2, a random number or code and a Receiver 2 one time public address is generated. Transaction data comprises (1) a masked amount of 6 units to the destination address corresponding to the Receiver 2 one time public address, and (2) a masked amount of the remaining 4 units to the destination address corresponding to the Receiver 1 one time public address 2. The transaction data is input to a smart contract 2107, which comprises the recorded transaction ID, a ring signature, and masked amount verification. The ring signature is generated by signing with the Receiver 1 one time private key along with signing by a number of decoy one time public keys. Any number (e.g., 10) of decoy keys may be used in the ring signature. The decoy key(s) may be generated by a central entity. Once the masked amount verification is complete (e.g., confirm sum), the first masked amount of 6 units may be sent to the Receiver 2 one time public address and the second masked amount of 4 units may be sent to the Receiver 1 one time public address.

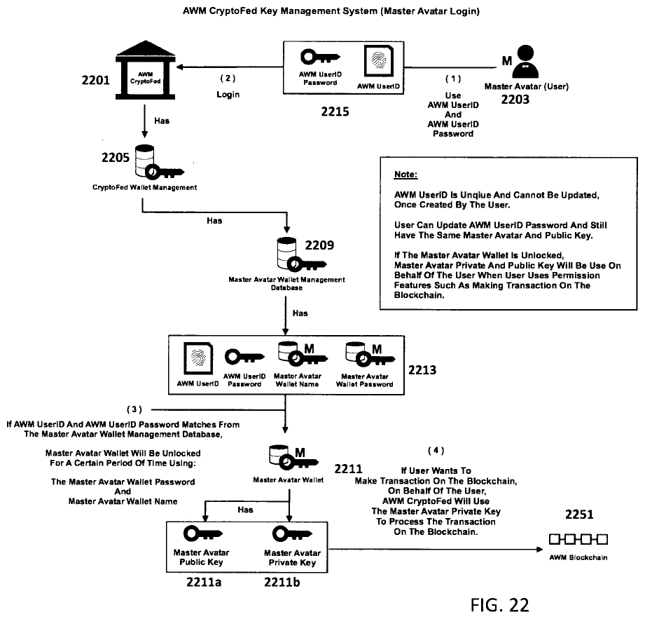

FIG. 22 illustrates a verifying entity key management system. A user, associated with master avatar 2203, may be registered with a verifying entity 2201. The user may access a master avatar key management system by logging in to the system with one or more user validation methods 2215 (e.g., by inputting a user ID (e.g., avatar ID) and corresponding password). The verifying entity 2201 may comprise (or have access to) a certifier wallet management database 2205. The certifier wallet management database 2205 may comprise a master avatar wallet management database 2209. The master avatar management database 2209 may comprise master avatar IDs, passwords, master avatar wallet names, and master avatar wallet passwords 2213. If the user ID and corresponding password input during log-in (e.g., 2215) matches the master avatar Ids and passwords stored on the master avatar management database 2209, the user may further unlock a master avatar wallet 2211 using a master avatar wallet name and corresponding master avatar wallet password. The master avatar wallet 2211 may comprise a master avatar public key 2211a and master avatar private key 2211b. When a user requests a transaction on blockchain 2251, the user may, or the verifying entity 2201 on behalf of the user may, use the master avatar private key 2211b to process the transaction on the blockchain 2251.

### Exemplary Use Case

In one of various use cases, the methods or systems presented herein provide a set of stable tokens (which may be named Ducat) and a set of non-stable tokens (which may be named Locke). There is an unlimited number of stable tokens for daily consumption, and consumers may not refund stable tokens back to USD, although the stable tokens are tradable at exchange platforms. The stable tokens are stable against the Personal Consumption Expenditures (PCE) index. For non-stable tokens, the number is finite, for example, there may be ten (10) trillion non-stable tokens. The non-stable tokens may be utilized to stabilize the stable token. The non-stable tokens are refundable via smart contracts, and tradable on exchange platforms. The non-stable tokens fluctuate against the stable tokens and other currencies (e.g., fiat currency).

To maintain zero inflation and deflation, the stable tokens are stable against the PCE index, which means the stable tokens rise against USD based on a formula linked to the PCE index. One example of the suitable formula can be: 1 stable token=1 USD+(Three Month Moving Average of Annual PCE Change/365), wherein the PCE may be found on a government source (e.g., website). This exchange rate between stable tokens and USD may be referred to as a target exchange rate. The target exchange rate (i.e., the stable tokens' value against the USD) may change on a daily basis. In some other embodiments, the change to a target exchange rate may be scheduled to be once a day, once a week, once a month, or in real-time, etc.

When there is a need to stabilize the stable tokens' value (e.g., when the actual exchange rate between the stable tokens and the USD deviates from the target exchange rate to a certain degree, such as 2%), the issuing entity (i.e., central entity, CryptoFed) of the monetary system may launch a trading between stable tokens and non-stable tokens. Non-stable token holders may exchange stable tokens with non-stable tokens to maintain the target exchange rate. The issuing entity may interfere (e.g., as instructed by the LQC controller) as needed to maintain the price range.

During the managed floating exchange rate phase, corporations and consumers may purchase stable tokens with USD at the issuing entity. The exchanges rate is fixed by a formula, such as: 1 stable token=1 USD+(Three Month Moving Average of Annual PCE Change/365). The issuing entity sells non-stable tokens via auctions from time to time. Each auction tranche will have a unique smart contract for refunding. Each purchaser in each auction has a unique wallet to initiate refunding of the purchase amount. All proceeds from the stable tokens sales may go to a USD Reserve fund dedicated to a merchant's Ducat redemption. All proceeds from the non-stable tokens sales may go to a USD Reserve fund dedicated to non-stable tokens refunding. Based on the rules of the issuing entity, according to one embodiment, the proceeds may not be used for other purposes. During the managed floating exchange rate phase, corporations (e.g., merchants, government, etc.) may convert stable tokens to USD at exchange platforms (e.g., crypto exchanges, issuing entity, central entity, CryptoFed, etc.). For example, at CryptoFed, the exchange rate may be fixed at 1 stable token=1 USD, even when the exchange rate is different than this at other exchange platforms. It is worth noticing that consumers may not convert stable tokens to USD at CryptoFed. This may ensure the stable tokens are for consumption purposes once hold by the consumers.

As described above, the non-stable tokens are of a finite number and subject to the risk of running out. Therefore, for each newly issued (e.g., newly-minted) stable tokens, an additional fraction of stable tokens may be issued and dedicated to a stable token reserve for buying back non-stable tokens or issuing dividend. In one example, the dividend is issued annually. In this case, at the end of each dividend period (e.g., each year, each month, each quarter, etc.), the remaining stable tokens in the reserve may be distributed to non-stable token holders as dividends.

When the outflow USD/inflow USD is greater than a threshold (e.g., >0.90), the issuing entity (e.g., central entity, CryptoFed) may increase the interest rate paid to stable tokens holders, and/or decrease the reward rate paid to consumers. When the outflow USD/inflow USD is smaller than a threshold (e.g., <0.70), the issuing entity (e.g., central entity, CryptoFed) may decrease interest rate paid to stable tokens holders, and/or increase reward rate paid to consumers.

There are two types of stable wallets. One is for corporations, and the other is for individuals (e.g., consumers). The stable tokens held at corporate wallets are called corporate holding stable tokens; and the stable tokens held at individual wallets are called individual holding stable tokens. Individual holding stable tokens do not have a dedicated USD reserve, because consumers cannot convert stable tokens to USD at CryptoFed, although they may exchange the stable tokens at crypto exchanges. There may be a corporate USD reserve ratio, which may be defined as corporate USD reserve/corporate holding stable tokens. Preferably, the corporate USD reserve ratio is maintained above a threshold, such as 1.2. When the corporate USD reserve ratio is below the threshold (e.g., 1.2), the issuing entity (e.g., CryptoFed) may adjust the reward rate and interest rate to recover the 1.2 ratio. When the sales tax amount in stable tokens exceeds USD in a number of jurisdictions (e.g., over 10 states), the issuing entity may start reducing the USD reserve to protect the issuing entity's assets. Some smart contracts may not be needed anymore, and some other smart contracts may be revised accordingly.

The stable tokens and/or non-stable tokens may be used for compensation payments to various parties, such as to employee, contractors, merchants' upgrade of POS, blockchain producers, and identity certifiers, etc. Token holders may exchange stable tokens and non-stable tokens for USD at exchange platforms as needed. The issuing entity (e.g., CryptoFed) may be organized in accordance with laws or regulations. In some embodiments, all compensation may be paid in stable tokens and non-stable tokens.

The mission of one exemplary issuing entity (e.g., CryptoFed) is to provide its members the following benefits:
an inflation protected stable token called Ducat for their economic activities,
zero fees for stable token (e.g., Ducat) transactions between and among members,
rewards for using Ducat (e.g., at a reward rate of 6.5%-16%) and interest for holding Ducat (at an interest rate of 3%-5%, which is higher than the net of Federal Funds Rate minus Inflation Rate)
other benefits adopted by members from time to time.

### Membership (Citizenship)

1. Individual membership requirements include the following:

Completing the KYC and AML process for FinCEN compliance, owning at least one stable token (e.g., Ducat) or one non-stable token (e.g., governance token, i.e., Locke), and signing Terms and Conditions, including but not limited to, appointment of the issuing entity (e.g., CryptoFed) as agent-of-a-payee for the member.

2. Corporate membership requirements include the following:

Completing the KYC and AML process for FinCEN compliance, signing an agreement with the issuing entity (e.g., CryptoFed) to appoint the issuing entity as agent-of-a-payee, to accept and use stable token (e.g., Ducat) and/or non-stable token (e.g., governance token, i.e., Locke).

### A Closed—Loop Blockchain Economy

The issuing entity (e.g., CryptoFed) creates a closed loop blockchain economy among its members, the border of which is clearly defined by the membership requirements. Both stable token (Ducat) and/or non-stable token (Locke) will be used for monetary transactions among members, such as, purchase at merchants, tuition at colleges, tax, payroll, contractor payments, identity certifier compensation, etc. Compliant crypto exchanges, such as Coinbase, Kraken, are the exits to the economies of foreign and fiat currencies of USD, Euro, Pound, Japanese Yen, Bitcoin, etc. Members can exchange stable token (Ducat) and non-stable token (Locke) for USD at exchanges as needed at their own discretion. stable token (Ducat) and non-stable token (Locke) each have a Closed Wallet for transactions among members and an Open Wallet for trading at crypto exchanges. In order to constantly improve the functions of the issuing entity (CryptoFed), project proposals can be initiated by members, broadcasted through the entire CryptoFed blockchain, voted for approval, auctioned for implementation and paid in stable token (Ducat) or non-stable token (Locke), etc.

### Ducat—An Inflation Protected Stable Token

The stable token (Ducat) is designed to have unlimited quantities for unlimited supply, which is for daily consumption use, such as purchase, tuition, payroll, tax, etc. Ducat will have a Target Exchange Rate between Ducat and USD to achieve zero inflation and deflation. There are a few different methods to activate the Target Exchange Rate, as described below:

Method 1

Ducat will rise against USD according to the deterministic function every day “t” since Ducat deployment (t=0):

1 Ducat=1 USD·e^{r}^{_{q}}^{·t}

where t is measured in days and

$${r}_{m} = \frac{1}{365} \cdot ln ( 1 + {R}_{m} )$$

and Rₘ=3 month trailing moving average of the annual percentage change of the PCE price index held fixed over the month and updated every month.

Method 2

Ducat will rise against USD according to the deterministic function every day “t” since Ducat deployment (t=0):

1 Ducat=1 USD·e^{r}^{ₘ}^{·t}

where t is measured in days and

$${r}_{m} = \frac{1}{365} \cdot ln ( 1 + {R}_{q} )$$

and Rₘ=estimated annual percentage change of the PCE price index which will be measured based on an exponential least square fit to a subset of the historical PCE data and held fixed over the month.

Method 3

Suppose time t is measured in days and m≥1 stands for months, then the Ducat will be designed to rise against USD according to the deterministic function every day “t” since Ducat deployment (t=0):

1 Ducat=1 USD·e^{Σ}^{ₘ₌₁}^{^{∞}}^{r}^{ₘ}^{(t)}

Such that:

$${r}_{m} ( t ) = \{ \begin{matrix}{r}_{m} t & if ( m - 1 ) τ + 1 \leq t \leq m τ \\ {r}_{m} m τ & if t > m τ \\ 0 & otherwise\end{matrix}$$

$${r}_{m} = \frac{1}{τ} \cdot ln ( {m}_{} / {m - 1}_{} )$$

$${0}_{} = {PCE}_{0}$$

$$τ = 365 / 12$$

[symbol] is an estimate of the Personal Consumption Expenditures Price index by the end of the month m. The estimate [symbol] is determined by an exponential least square fit to a subset of the historical PCE data released by the Department of Commerce in previous months m−1, m−2, . . . etc.

As described above, the PCE Price Index is published by a government department (US Department of Commerce) every month.

Ducat is tradable at compliant crypto exchanges under the condition that the exchanges will only allow Ducat to be transferred to wallets provided by the issuing entity (e.g., CryptoFed). The price range at exchanges will be controlled at 2% deviation of Target Exchange Rate by CryptoFed via trading operation between USD and Ducat or between Ducat and Locke as instructed by Linear Quadratic Gaussian (LQG) mathematical controller. Ducat can always be purchased and sold at exchanges at the market price.

USD Outflow Inflow Ratio and Corporate USD Reserve Ratio defined below are two measurements for system stability at inception stage. Linear Quadratic Gaussian (LQG) mathematical controller will be established to provide CryptoFed instructions to maintain the stability.
i. USD Outflow Inflow Ratio is defined as (Total USD Outflow from CryptoFed)/(Total USD Inflow to CryptoFed).
   When Outflow USD/Inflow USD>0.90, CryptoFed increases interest rate paid to Ducat holders and decreases reward rate paid to consumers. When Outflow USD/Inflow USD<0.70, CryptoFed decreases interest rate paid to Ducat holders and increases reward rate paid to consumers.
ii. Ducat held at corporate wallets is called Corporate Holding Ducat for which a dedicated USD Reserve is established for converting Ducat to USD by corporate members, such as merchants, governments, corporations, etc. The Corporate USD Reserve Ratio is defined as Corporate USD Reserve/Corporate Holding Ducat. Corporate USD Reserve Ratio>1.2 will be maintained. When it is below 1.2, CryptoFed will adjust rewards rates and interest rate to recover the 1.2 ratio.

### Locke—A Governance (Non-Stable) Token

As described above, there is a finite number of 10 trillion of non-stable tokens (Locke) issued, and controlled by an immutable smart contract.

In one embodiment, Locke is used for trading operations between Ducat and Locke at crypto exchanges so that Ducat's exchange rate against USD is maintained within a 2% deviation of Target Exchange Rate. Locke holders' roles are to buy Ducat with Locke or sell Ducat for Locke to maintain this Target Exchange Rate at crypto exchanges. When the market fails to maintain the Target Exchange Rate, CryptoFed interferes decisively as instructed by Linear Quadratic Gaussian (LQG) mathematical controller to recover the price range through trading between Locke and Ducat. It is also possible that CryptoFed will sell Ducat for USD when Ducat is higher than the Target Exchange Rate, while buying Ducat with Locke when Ducat is lower than the Target Exchange Rate.

The purpose of Locke sales is to propagate Locke among members so that there are sufficient Locke holders to play the role of trading operation.

As described above, in some embodiments, the issuing entity (CryptoFed) will sell Locke via auctions from time to time. Each auction tranche will have a unique smart contract for refunding. Each purchaser of each auction will have a unique wallet to initiate refunding of the purchase amount. The unique wallet of the unique purchaser will expire once all purchase amounts have been refunded.

In some embodiments, Locke is tradable at compliant crypto exchanges under the condition that the exchanges will only allow Locke to be transferred to wallets provided by the issuing entity (CryptoFed). Locke can be purchased and sold at exchanges at the market price.

### Ducat Reserve for Locke Buyback and Annual Dividend

In some embodiment, as described above, for each newly minted Ducat, an additional certain amount (e.g., 0.1) of Ducat will be minted and dedicated to a fund for buying back Locke or paying annual dividends, because Locke has a finite number and is subject to the risk of running out. At the end of each year, the remaining of the Ducat fund will be distributed to Locke holders as dividend.

### CryptoFed Exchange

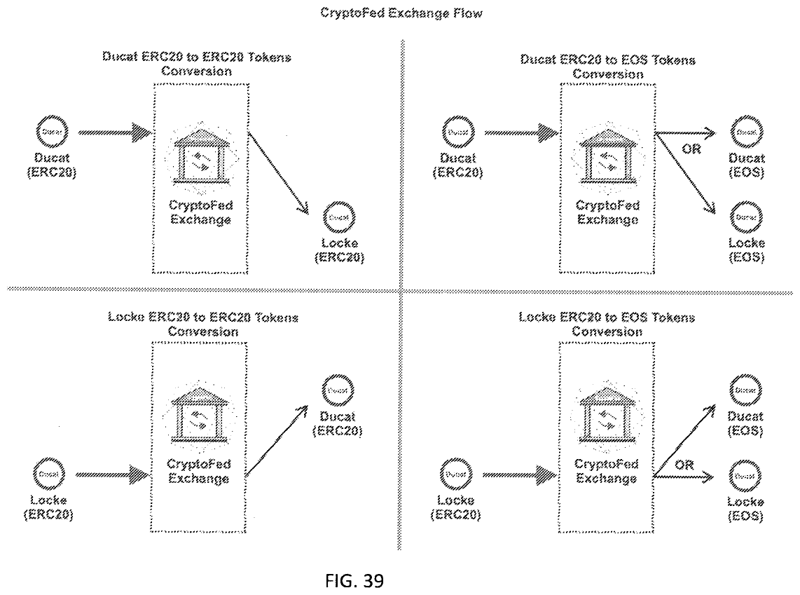

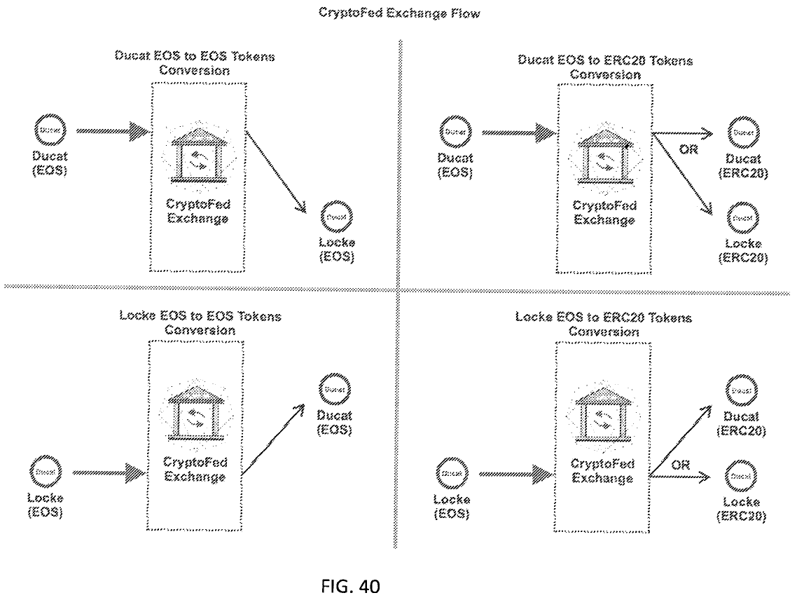

CryptoFed Exchange (e.g., issuing entity exchange) is for internal use among members and only has two trading pairs below. Members can use both the internal CryptoFed Exchange or external compliant crypto exchanges, such as Coinbase, Kraken, etc. Only when Ducat's exchange rate against USD is beyond the 2% deviation range of Target Exchange Rate, will CryptoFed interfere through internal CryptoFed Exchange and/or external compliant crypto exchanges, to recover the Target Exchange Rate.
i. Ducat/USD
The purpose is to achieve and maintain the Target Exchange Rate between Ducat and USD through market force. Independent of the market price at CryptoFed Exchange, members can always purchase Ducat directly from CryptoFed at the Target Exchange Rate, while corporate members can always convert Ducat to USD at 1 Ducate=1 USD at CryptoFed. FIG. 39 shows a diagram illustrating an exemplary issuing entity exchange flow. In FIG. 39, exchanges between Ducat (ERC 20) and Locke (ERC 20) may be facilitated by an issuing entity exchange (e.g., CryptoFed Exchange). FIG. 40 shows a diagram illustrating an exemplary issuing entity exchange flow. In FIG. 40, exchanges between Ducat (EOS) and Locke (EOS) may be facilitated by an issuing entity exchange (e.g., CryptoFed Exchange). The exchange flow processes shown in FIG. 39 and FIG. 40 can also be used as part of the CryptoFed Exchange.
ii. Ducat/Locke
The purpose is to adjust Ducat supply using Locke′ buying and selling which will also help achieve the Target Exchange Rate between Ducat and USD.

### Reduction of US Dollar Reserve

When the sales tax amount in Ducat exceeds US Dollar in more than 10 states in the US, CryptoFed can start reducing the US Dollar reserve to protect CryptoFed assets because USD can lose value against Ducat due to USD inflation.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for creating a stable token of zero inflation and zero deflation, comprising:
providing:
i) a stable token, wherein the stable token is associated with a) a reward rate for purchase using the stable token; b) an interest rate for holding the stable token, and c) a weighted average price index for measuring inflation and deflation of the stable token,
ii) a non-stable token,
iii) an exchange for trading between the stable token and the non-stable token, and
v) a Linear-Quadratic-Gaussian (LQG) controller,
wherein the LQC controller is configured to automatically optimize one or more of the reward rate, the interest rate, and the trading between the non-stable token and the stable token, to target or maintain zero inflation and deflation of the stable token,
wherein the LQG controller is configured to perform one or more of: reduce the reward rate, increase the interest rate, and reduces the stable token supply by buying back the stable tokens with the non-stable token when the LQG controller determines or detects a tendency for inflation of the stable token, and
wherein the LQG controller is configured to perform one or more of: increase the reward rate, decrease the interest rate, and increase the stable token supply by buying back the non-stable tokens with the stable token when the LQG controller determines or detects a tendency for deflation of the stable token.

2. The method of claim 1, wherein respective frequencies of adjusting the reward rate, adjusting the interest rate, and the trading between the stable token and the non-stable token by the LQG controller are different than each other.

3. The method of claim 1, wherein the LQG controller is configured to only adjust the reward rate.

4. The method of claim 1, wherein the LQG controller is configured to only adjust the interest rate.

5. The method of claim 1, wherein the LQG controller is configured to adjust both the reward rate and the interest rate.

6. The method of claim 1, wherein LQG controller is configured to adjust the reward rate and interest rate at a frequency of fewer than 10 times per year.

7. The method of claim 1, wherein LQG controller is configured to adjust trading between the stable token and the non-stable token at a frequency of once per day.

8. The method of claim 1, further comprising masking a transaction of the stable token by:
i. providing a first database accessible by a certifier entity, comprising protected data, wherein the protected data is assigned an identifier; and
ii. providing a second database, comprising transactional records associated with the identifier, wherein the transactional records are encrypted by (1) a first key corresponding to a private key of the certifier entity and (2) a second key corresponding to a private key of a master avatar associated with the identifier, wherein the second key is managed by the central entity or a user associated with the master avatar, wherein in order to search for the transactional records associated with the identifier, two keys must be provided to the second database.

9. The method of claim 8, wherein the certifier entity does not have access to the second key.

10. The method of claim 8, wherein the identifier is hashed data.

11. The method of claim 8, wherein the identifier has been verified by both a user assigned to the identifier and the certifier entity.

12. The method of claim 8, wherein the identifier is first verified by a user assigned to the identifier and second by a certifier entity.

13. A system for masking a transaction, comprising:
a first database accessible by a certifier entity, comprising protected data, wherein the protected data is assigned an identifier; and
a second database, comprising transactional records associated with the identity identifier, wherein the transactional records are encrypted by (1) a first key corresponding to a private key of the certifier entity and (2) a second key corresponding to a private key of a master avatar associated with the identifier,
wherein the second key is managed by the central entity or a user associated with the master avatar,
wherein in order to search for the transactional records associated with the identifier, two keys are provided to the second database.

14. The system of claim 13, wherein the certifier entity does not have access to the second key.

15. The system of claim 13, wherein the identifier is hashed data.

16. The system of claim 13, wherein the identifier has been verified by both a user assigned to the identifier and the certifier entity.

17. A method for facilitating payment of the stable token, comprising:
i. receiving, at a server in communication with a central entity, from a user device of a first user, a selection of a digital token transfer method to a second user;
ii. processing said digital token transfer method, by said server, by initiating a transfer of digital tokens from a digital account of said first user to a digital account of said central entity and substantially simultaneously initiating a transfer of a same amount of said digital tokens from said central entity to an account of said second user; and
iii. receiving, at a server in communication with said central entity, from a second device of said second user a request to issue an incentive amount of digital tokens to said first user and substantially simultaneously initiate a transfer of said digital tokens of the same incentive amount from said account of said second user to said first user.

18. The method of claim 17, wherein the central entity has received verification of an identity of the first user and an identity of the second user.

19. The method of claim 17, further comprising, prior to (a), initiating a transfer of fiat currency from a financial institution account of said first user to a financial institution of said central entity, and substantially simultaneously initiating a transfer of digital tokens from said central entity to an account of said first user.

20. The method of claim 19, wherein the initiating is performed on a web-based interface.

21. The method of claim 19, wherein the initiating is performed on a mobile-web interface.

22. The method of claim 19, further comprising receiving a selection of a digital token transfer to the second user and a third user simultaneously.

23. A system for facilitating payment of the stable token, comprising:
a server in communication with a blockchain network and a central entity, wherein the server comprises one or more processors, individually or collectively, configured to:
i. receive from a first user device of a first user, a selection of a digital token transfer method to a second user;
ii. process said digital token transfer method, by said server, by initiating a transfer of digital tokens from a digital account of said first user to a digital account of said central entity on said blockchain and substantially simultaneously initiating a transfer of a same amount of said digital tokens from said central entity to an account of said second user; and
iii. receive, at a server in communication with said central entity, from a second device of said second user a request to issue a reward amount of digital tokens to said first user and substantially simultaneously initiating a transfer of said digital tokens of a same reward amount from said account of said second user to said first user.

24. The system of claim 23, wherein the central entity has received verification of an identify of the first user and an identity of the second user.

25. The system of claim 23, wherein the one or more processors are, individually or collectively, further configured to, receive fund transfer initiation from the first user to the second user.

26. The system of claim 23, wherein the one or more processors are, individually or collectively, further configured to, provide a mobile-based interface for the fund transfer initiation to the user device.
